(19) United States
(12) Patent Application Publication
(10) Pub. No.: US 2026/0052541 A1
(43) Pub. Date: Feb. 19, 2026

(54) DOWNLINK CONTROL INFORMATION MULTIPLEXED WITH SEMI-PERSISTENT SCHEDULING PHYSICAL DOWNLINK SHARED CHANNEL TRANSMISSIONS

(71) Applicant: QUALCOMM Incorporated, San Diego, CA (US)

(72) Inventors: Yi HUANG, San Diego, CA (US); Jing SUN, San Diego, CA (US); Mostafa KHOSHNEVISAN, San Diego, CA (US); Chih-Hao LIU, San Diego, CA (US)

(21) Appl. No.: 18/802,573

(22) Filed: Aug. 13, 2024

(51) Int. Cl. H04W 72/232; H04W 72/04

(52) U.S. Cl. CPC H04W 72/232; H04W 72/04

(57) ABSTRACT

Various aspects of the present disclosure generally relate to wireless communication. Some aspects more specifically relate to downlink control information (DCI) multiplexed with one or semi-persistent scheduling (SPS) physical downlink shared channel (PDSCH) transmissions. In some aspects, a user equipment (UE) may receive a DCI message that is multiplexed with an SPS PDSCH transmission of a series of SPS PDSCH transmissions. In some aspects, a DCI message that is multiplexed with an SPS PDSCH transmission may be used to dynamically adjust transmission parameters associated with one or more SPS PDSCH transmissions of the series of SPS PDSCH transmissions. In some other aspects, the DCI message that is multiplexed with the SPS PDSCH transmission may be used to dynamically schedule a dynamic grant PDSCH transmission.

### FIELD OF THE DISCLOSURE

Aspects of the present disclosure generally relate to wireless communication and specifically relate to techniques, apparatuses, and methods associated with downlink control information multiplexed with semi-persistent scheduling physical downlink shared channel transmissions.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

In some examples, a user equipment (UE) in a wireless communication system may be capable of operating in a reduced-power mode, such as for a purpose of conserving energy at the UE. However, the UE may have to periodically exit the reduced-power mode (for example, the UE may need to “wake up”) to receive scheduled downlink communications, such as control communications and/or data communications. If the UE needs to often wake up and/or needs to wake up for large periods of time, the energy-savings benefits of operating in the reduced-power mode may be mitigated.

### SUMMARY

Some aspects described herein relate to a method for wireless communication by a user equipment (UE). The method may include receiving configuration information that configures a series of semi-persistent scheduling (SPS) physical downlink shared channel (PDSCH) transmissions. The method may include monitoring the series of SPS PDSCH transmissions for downlink control information (DCI) in accordance with the configuration information. The method may include receiving a DCI message multiplexed with an SPS PDSCH transmission of the series of SPS PDSCH transmissions.

Some aspects described herein relate to a method for wireless communication by a network node. The method may include transmitting, to a UE, configuration information that configures a series of SPS PDSCH transmissions. The method may include transmitting, to the UE, a DCI message multiplexed with an SPS PDSCH transmission of the series of SPS PDSCH transmissions in accordance with the configuration information.

Some aspects described herein relate to a UE for wireless communication. The UE may include a processing system that includes one or more processors and one or more memories coupled with the one or more processors. The processing system may be configured to cause the UE to receive configuration information that configures a series of SPS PDSCH transmissions. The processing system may be configured to cause the UE to monitor the series of SPS PDSCH transmissions for DCI in accordance with the configuration information. The processing system may be configured to cause the UE to receive a DCI message multiplexed with an SPS PDSCH transmission of the series of SPS PDSCH transmissions.

Some aspects described herein relate to a network node for wireless communication. The network node may include a processing system that includes one or more processors and one or more memories coupled with the one or more processors. The processing system may be configured to cause the network node to transmit, to a UE, configuration information that configures a series of SPS PDSCH transmissions. The processing system may be configured to cause the network node to transmit, to the UE, a DCI message multiplexed with an SPS PDSCH transmission of the series of SPS PDSCH transmissions in accordance with the configuration information.

Some aspects described herein relate to a non-transitory computer-readable medium that stores a set of instructions for wireless communication by a UE. The set of instructions, when executed by one or more processors of the UE, may cause the UE to receive configuration information that configures a series of SPS PDSCH transmissions. The set of instructions, when executed by one or more processors of the UE, may cause the UE to monitor the series of SPS PDSCH transmissions for DCI in accordance with the configuration information. The set of instructions, when executed by one or more processors of the UE, may cause the UE to receive a DCI message multiplexed with an SPS PDSCH transmission of the series of SPS PDSCH transmissions.

Some aspects described herein relate to a non-transitory computer-readable medium that stores a set of instructions for wireless communication by a network node. The set of instructions, when executed by one or more processors of the network node, may cause the network node to transmit, to a UE, configuration information that configures a series of SPS PDSCH transmissions. The set of instructions, when executed by one or more processors of the network node, may cause the network node to transmit, to the UE, a DCI message multiplexed with an SPS PDSCH transmission of the series of SPS PDSCH transmissions in accordance with the configuration information.

Some aspects described herein relate to an apparatus for wireless communication. The apparatus may include means for receiving configuration information that configures a series of SPS PDSCH transmissions. The apparatus may include means for monitoring the series of SPS PDSCH transmissions for DCI in accordance with the configuration information. The apparatus may include means for receiving a DCI message multiplexed with an SPS PDSCH transmission of the series of SPS PDSCH transmissions.

Some aspects described herein relate to an apparatus for wireless communication. The apparatus may include means for transmitting, to a UE, configuration information that configures a series of SPS PDSCH transmissions. The apparatus may include means for transmitting, to the UE, a DCI message multiplexed with an SPS PDSCH transmission of the series of SPS PDSCH transmissions in accordance with the configuration information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of a downlink semi-persistent scheduling (SPS) communication in accordance with the present disclosure.

FIG. 5A-5G are diagrams of examples associated with downlink control information (DCI) multiplexed with SPS physical downlink shared channel (PDSCH) transmissions, in accordance with the present disclosure.

FIG. 6 is a flowchart illustrating an example process performed, for example, at a UE or an apparatus of a UE that supports a series of SPS PDSCH transmissions in accordance with the present disclosure.

FIG. 7 is a flowchart illustrating an example process performed, for example, at a network node or an apparatus of a network node that supports a series of SPS PDSCH transmissions in accordance with the present disclosure.

FIG. 8 is a diagram of an example apparatus for wireless communication that supports DCI multiplexed with SPS PDSCH transmissions in accordance with the present disclosure.

FIG. 9 is a diagram of an example apparatus for wireless communication that supports DCI multiplexed with SPS PDSCH transmissions in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, in order to conserve energy at a user equipment (UE) or for a similar purpose, a UE in a wireless communication system may be capable of operating in a reduced-power mode, such as a radio resource control (RRC) idle mode, an RRC inactive mode, a discontinuous reception (DRX) and/or a discontinuous transmission (DTX) mode, among other examples. When in a reduced-power mode, the UE may be required to periodically wake up (for example, exit the reduced-power mode) to receive downlink control and/or data communications. For example, the UE may be configured to receive semi-persistent scheduling (SPS) downlink communications, such as SPS physical downlink shared channel (PDSCH) transmissions. Accordingly, the UE may need to periodically wake up to monitor and/or decode the various SPS PDSCH transmissions. Moreover, the UE may need to periodically wake up to receive other downlink communications, such as physical downlink control channel (PDCCH) transmissions and/or downlink control information (DCI) messages, among other examples. Accordingly, in some examples the UE may need to often wake up and/or the UE may be associated with large periods of wake up time, reducing the energy-savings benefits of operating in the reduced-power mode in the first place and/or otherwise requiring high consumption of power, computing, and network resources by the UE and/or the network node.

Various aspects relate generally to SPS PDSCH transmissions for wireless communication. Some aspects more specifically relate to DCI multiplexed with one or SPS PDSCH transmissions. In some aspects, a UE may receive downlink control messages, such as PDCCH communications and/or DCI messages, that are multiplexed with an SPS downlink communication, such as an SPS PDSCH transmission of a series of SPS PDSCH transmissions. In some aspects, the UE may be configured with a periodicity for including one or more DCI messages in a subset of SPS PDSCH transmissions of the series of SPS PDSCH transmissions, and thus the UE may monitor the series of the SPS PDSCH transmissions for the DCI in accordance with the periodicity. Additionally or alternatively, a DCI message that is multiplexed with an SPS PDSCH transmission may be used to dynamically adjust transmission parameters associated with one or more SPS PDSCH transmissions. For example, a DCI message that is multiplexed with an SPS PDSCH transmission may be used to indicate a change in a time-domain location of a subsequent SPS PDSCH transmission of the series of SPS PDSCH transmission, such as by using a KO field of a time domain resource allocation. In some other aspects, the DCI message that is multiplexed with the SPS PDSCH transmission may be used to dynamically schedule a dynamic grant (DG) PDSCH communication. Additionally or alternatively, the UE may identify whether a DCI message that is multiplexed with an SPS PDSCH transmission indicates one or more transmission parameters of one or more SPS PDSCH transmissions or else schedules a DG PDSCH communication, such as by identifying that the DCI message indicates one or more transmission parameters of one or more SPS PDSCH transmissions when a cyclic redundancy check (CRC) associated with the DCI is scrambled by a configured scheduling radio network temporary identifier (RNTI), and/or by identifying that the DCI message schedules the DG PDSCH communication when the CRC is scrambled by one of a cell RNTI or a temporary cell RNTI.

Particular aspects of the subject matter described in this disclosure can be implemented to realize one or more of the following potential advantages. In some examples, the described techniques can be used to reduce a quantity of occasions that a UE would otherwise be required to wake up and receive downlink communications and/or reduce a total amount of time that a UE needs to spend in a full-power mode, because when the UE wakes up to monitor and/or decode an SPS PDSCH transmission, the UE may also receive a control message (for example, a DCI message) that the UE would otherwise be required to wake up and receive on a separate occasion, thereby reducing power consumption associated with the UE receiving DCI messages. In some examples, by configuring a UE with a periodicity for including one or more DCI messages in a subset of SPS PDSCH transmissions, the described techniques may conserve power, computing, and other resources otherwise consumed by the UE blindly decoding each SPS PDSCH transmission for potential inclusion of DCI. In some other examples, by multiplexing a DCI message with an SPS PDSCH transmission that is used to dynamically adjust transmission parameters associated with one or more SPS PDSCH transmissions, the described techniques may reduce computing, power, and/or network resource consumption otherwise associated with a network node transmitting, and the UE receiving, one or more reactivation DCI messages for adjusting transmission parameters of a series of SPS PDSCH transmissions. For example, by using a DCI message that is multiplexed with an SPS PDSCH transmission to indicate a change in a time-domain location of a subsequent SPS PDSCH transmission, the described techniques may reduce computing, power, and/or network resource consumption otherwise associated with the network node transmitting, and the UE receiving, one or more reactivation DCI messages for adjusting time-domain locations of certain SPS PDSCH transmissions. Additionally or alternatively, by multiplexing a DCI message with an SPS PDSCH transmission that is used to dynamically schedule a DG PDSCH communication, the described techniques may reduce computing, power, and/or network resource consumption associated with the network node transmitting, and the UE receiving, one or more PDCCH messages for scheduling DG PDSCH communications. Moreover, by scrambling a CRC of a DCI message with one of a configured scheduling RNTI to indicate that the DCI message is being used to adjust one or more transmission parameters, or else one of a cell RNTI or a temporary cell RNTI to indicate that the DCI message is being used to schedule a DG PDSCH, the UE and the network node may communicate with increased transparency thereby reducing communication errors, and thus reducing power, computing, and network resource consumption otherwise associated with correcting communication errors.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

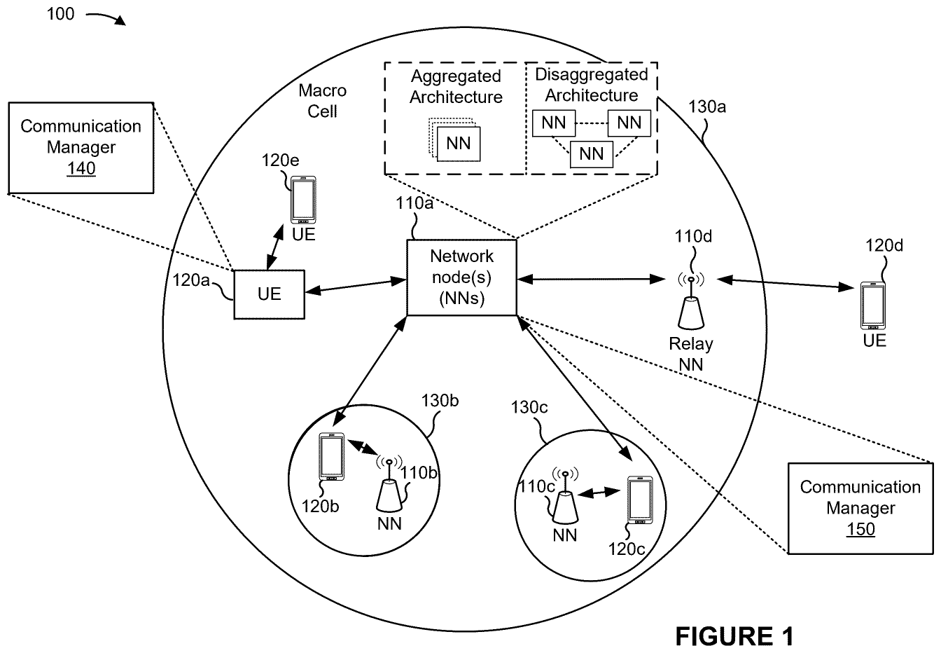

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some examples, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FRI is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FRI and FR2 are often referred to as mid-band frequencies, which include FR3. Frequency bands falling within FR3 may inherit FR1 characteristics or FR2 characteristics, and thus may effectively extend features of FRI or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1. FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on or otherwise associated with user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B. an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, in accordance with a functional split, such as a lower layer functional split. In such an architecture, each RU can be operated to handle over the air (OTA) communication with one or more UEs 120.

In some examples, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU. and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move in accordance with the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit DCI (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more PDCCHs, and downlink data channels may include one or more PDSCHs. Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on or otherwise associated with changing network conditions in the wireless communication network 100 and/or based on or otherwise associated with the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some examples, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In such examples, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified in accordance with different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IOT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive configuration information that configures a series of SPS PDSCH transmissions; monitor the series of SPS PDSCH transmissions for DCI in accordance with the configuration information; and receive a DCI message multiplexed with an SPS PDSCH transmission of the series of SPS PDSCH transmissions. Additionally or alternatively, the communication manager 140 may perform one or more other operations described herein.

In some aspects, the network node 110 may include a communication manager 150. As described in more detail elsewhere herein, the communication manager 150 may transmit, to a UE, configuration information that configures a series of SPS PDSCH transmissions; and transmit, to the UE, a DCI message multiplexed with an SPS PDSCH transmission of the series of SPS PDSCH transmissions in accordance with the configuration information. Additionally or alternatively, the communication manager 150 may perform one or more other operations described herein.

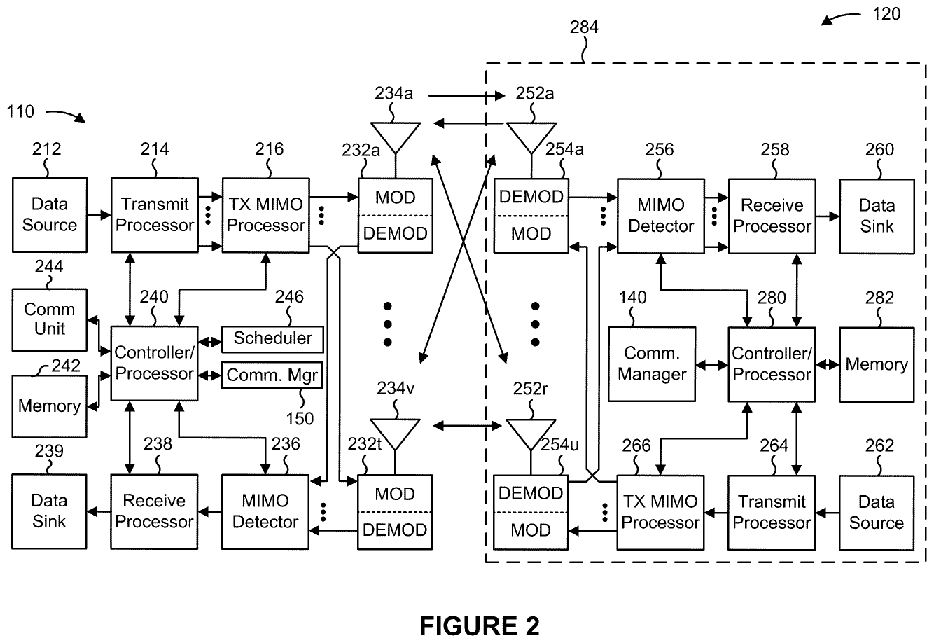

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some examples in conjunction with processor-readable code stored in the memory 242, to perform aspects of the methods, processes, and/or operations described herein. In some examples, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some examples, a single processor may perform all of the operations described as being performed by the one or more processors. In some examples, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may transmit a set of output symbol streams (for example, T output symbol streams) to the set of modems 232. For example, each output symbol stream may be transmitted to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example. T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may transmit the decoded data to a data sink 239 (which may be a data pipeline, a data queue, and/or another type of data sink) and transmit the decoded control information to a processor, such as the controller/processor 240.

The network node 110 may use the scheduler 246 to schedule one or more UEs 120 for downlink or uplink communications. In some examples, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform SPS or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some examples, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some examples, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some examples in conjunction with processor-readable code stored in the memory 282, to perform aspects of the methods, processes, or operations described herein. In some examples, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may transmit a set of received downlink signals (for example, R received signals) to the set of modems 254. For example, each received signal may be transmitted to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may transmit detected symbols. The receive processor 258 may process (for example, decode) the detected symbols, may transmit decoded data for the UE 120 to the data sink 260 (which may include a data pipeline, a data queue, and/or an application executed on the UE 120), and may transmit decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some examples, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for discrete Fourier transform spread OFDM (DFT-s-OFDM) or cyclic prefix OFDM (CP-OFDM)). The TX MIMO processor 266 may perform spatial processing (for example, precoding) on the data symbols, the control symbols, the overhead symbols, and/or the reference symbols, if applicable, and may transmit a set of output symbol streams (for example, U output symbol streams) to the set of modems 254. For example, each output symbol stream may be transmitted to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may transmit a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different quantities of antenna elements. For example, a UE 120 may include a single antenna element, two antenna elements, four antenna elements, eight antenna elements, or a different quantity of antenna elements. As another example, a network node 110 may include eight antenna elements, 24 antenna elements, 64 antenna elements, 128 antenna elements, or a different quantity of antenna elements. Generally, a larger quantity of antenna elements may provide increased control over parameters for beam generation relative to a smaller quantity of antenna elements, whereas a smaller quantity of antenna elements may be less complex to implement and may use less power than a larger quantity of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

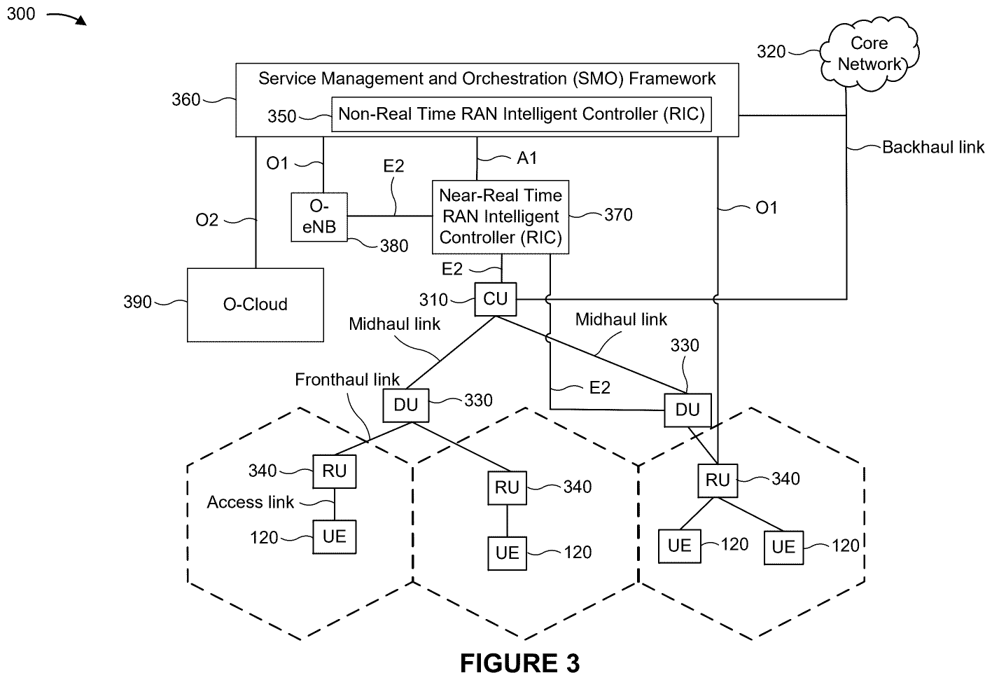

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some examples, the CU 310 may be logically split into one or more CU user plane (CU-UP) units and one or more CU control plane (CU-CP) units. A CU-UP unit may communicate bidirectionally with a CU-CP unit via an interface, such as the El interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some examples, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some examples, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some examples, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

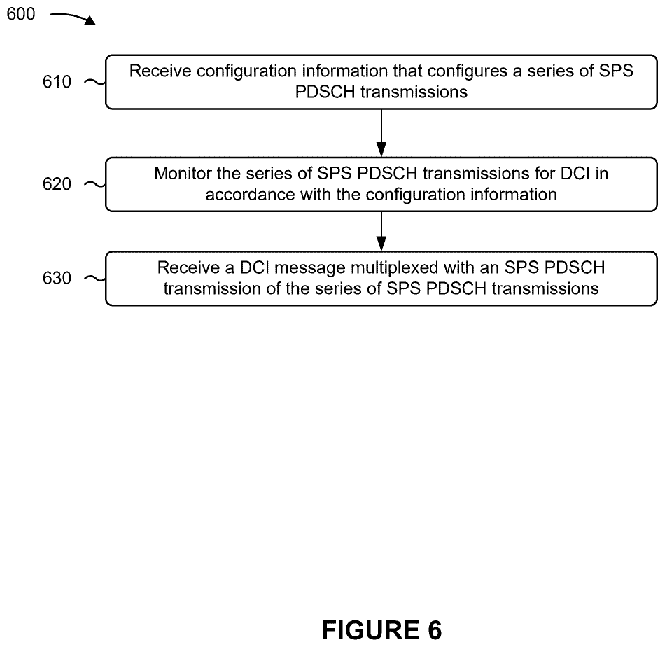

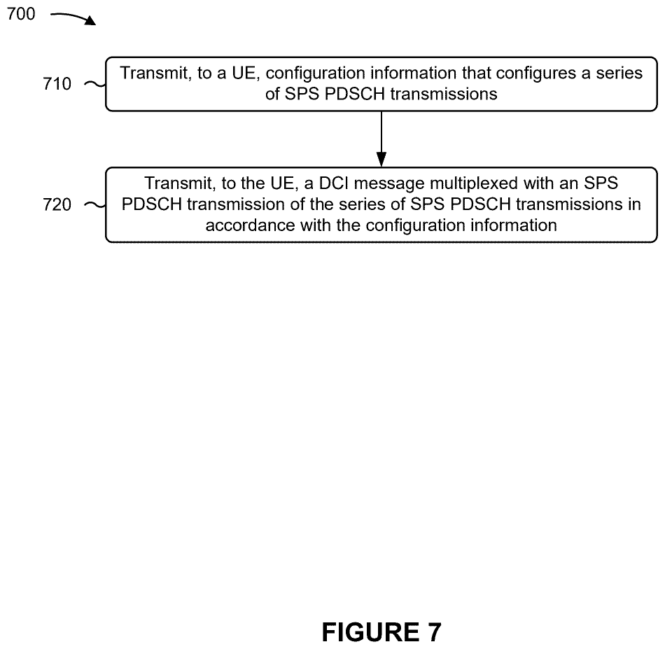

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with DCI multiplexed with SPS PDSCH transmissions, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 600 of FIG. 6, process 700 of FIG. 7, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

In some aspects, the UE 120 includes means for receiving configuration information that configures a series of SPS PDSCH transmissions; means for monitoring the series of SPS PDSCH transmissions for DCI in accordance with the configuration information; and/or means for receiving a DCI message multiplexed with an SPS PDSCH transmission of the series of SPS PDSCH transmissions. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE, configuration information that configures a series of SPS PDSCH transmissions; and/or means for transmitting, to the UE, a DCI message multiplexed with an SPS PDSCH transmission of the series of SPS PDSCH transmissions in accordance with the configuration information. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

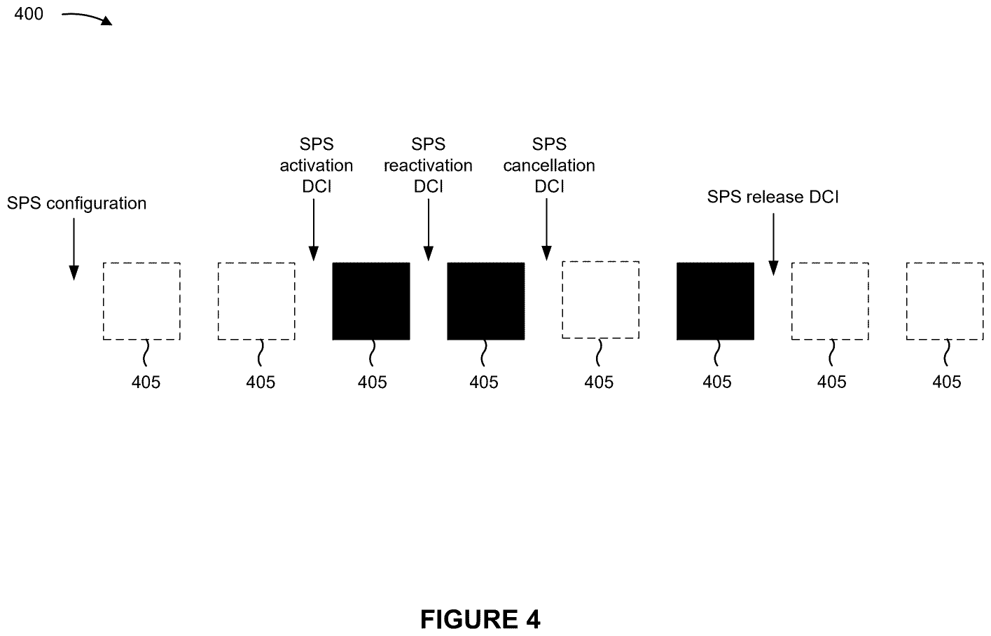

FIG. 4 is a diagram illustrating an example 400 of downlink SPS communication, in accordance with the present disclosure. SPS communications may include periodic downlink communications that are configured for a UE, such that a network node does not need to transmit (for example, directly or via one or more network nodes) separate DCI to schedule each downlink communication, thereby conserving signaling overhead.

As shown in example 400, a UE may be configured with an SPS configuration for SPS communications. For example, the UE may receive the SPS configuration via an RRC message transmitted by a network node (for example, directly or via one or more network nodes). The SPS configuration may indicate a resource allocation associated with SPS downlink communications (for example, in a time domain, frequency domain, spatial domain, and/or code domain) and a periodicity at which the resource allocation is repeated, resulting in periodically reoccurring scheduled SPS occasions 405 for the UE. The SPS configuration may also configure hybrid automatic repeat request (HARQ)-acknowledgement (ACK) (HARQ-ACK) feedback resources for the UE to transmit HARQ-ACK feedback for SPS PDSCH communications received in the SPS occasions 405. For example, the SPS configuration may indicate a PDSCH-to-HARQ feedback timing value, which may be referred to as a K1 value in a wireless communication standard (for example, a 3GPP standard).

The network node may transmit SPS activation DCI to the UE (for example, directly or via one or more network nodes) to activate the SPS configuration for the UE. The network node may indicate, in the SPS activation DCI, communication parameters, such as an MCS, a resource block (RB) allocation, and/or antenna ports, for the SPS PDSCH communications to be transmitted in the scheduled SPS occasions 405. The UE may begin monitoring the SPS occasions 405 based at least in part on receiving the SPS activation DCI. For example, beginning with a next scheduled SPS occasion 405 subsequent to receiving the SPS activation DCI, the UE may monitor the scheduled SPS occasions 405 to decode PDSCH communications using the communication parameters indicated in the SPS activation DCI. The UE may refrain from monitoring configured SPS occasions 405 prior to receiving the SPS activation DCI. The network node may transmit SPS reactivation DCI to the UE (for example,

directly or via one or more network nodes) to change the communication parameters for the SPS PDSCH communications. Based at least in part on receiving the SPS reactivation DCI, the UE may begin monitoring the scheduled SPS occasions 405 using the communication parameters indicated in the SPS reactivation DCI. For example, beginning with a next scheduled SPS occasion 405 subsequent to receiving the SPS reactivation DCI, the UE may monitor the scheduled SPS occasions 405 to decode PDSCH communications based on or otherwise associated with the communication parameters indicated in the SPS reactivation DCI.

In some cases, such as when there is not downlink traffic to transmit to the UE, the network node may transmit SPS cancellation DCI to the UE (for example, directly or via one or more network nodes) to temporarily cancel or deactivate one or more subsequent SPS occasions 405 for the UE. The SPS cancellation DCI may deactivate only a subsequent one SPS occasion 405 or a subsequent N SPS occasions 405 (where N is an integer). SPS occasions 405 after the one or more (for example, N) SPS occasions 405 subsequent to the SPS cancellation DCI may remain activated. Based at least in part on receiving the SPS cancellation DCI, the UE may refrain from monitoring the one or more (for example, N) SPS occasions 405 subsequent to receiving the SPS cancellation DCI. As shown in example 400, the SPS cancellation DCI cancels one subsequent SPS occasion 405 for the UE. After the SPS occasion 405 (or N SPS occasions) subsequent to receiving the SPS cancellation DCI, the UE may automatically resume monitoring the scheduled SPS occasions 405.

The network node may transmit SPS release DCI to the UE (for example, directly or via one or more network nodes) to deactivate the SPS configuration for the UE. The UE may stop monitoring the scheduled SPS occasions 405 based at least in part on receiving the SPS release DCI. For example, the UE may refrain from monitoring any scheduled SPS occasions 405 until another SPS activation DCI is received by the UE. Whereas the SPS cancellation DCI may deactivate only a subsequent one SPS occasion 405 or a subsequent N SPS occasions 405. the SPS release DCI deactivates all subsequent SPS occasions 405 for a given SPS configuration for the UE until the given SPS configuration is activated again by a new SPS activation DCI.

In some examples, in order to conserve energy at the UE 120 or otherwise, a UE 120 may be capable of operating in a reduced-power mode, such as an RRC idle mode, an RRC inactive mode, a DRX mode, a DTX mode, and/or a similar mode. However, in examples in which the UE 120 is configured to receive an SPS downlink communication, such as a series of SPS PDSCH transmissions and/or the SPS downlink communication described above in connection with example 400, the UE 120 may need to periodically wake up (for example, exit a reduced-power mode) to monitor and/or decode the various SPS occasions 405. Moreover, the UE 120 may have to periodically wake up to receive other downlink communications, such as PDCCH transmissions and/or DCI messages, among other examples. Accordingly, in some examples the UE 120 may need to wake up often and/or may need to wake up for large periods of time to receive downlink communications, reducing the energy-savings benefits of operating in the reduced-power mode in the first place and/or otherwise requiring high signaling overhead and thus high consumption of power, computing, and network resources.

Some techniques and aspects described herein enable improved energy-savings operations for a UE 120. More particularly, some techniques and aspects described herein enable reduction of a quantity of wake up occasions associated with the UE 120 and/or enable reduction in wake-up time associated with the UE 120 operating in a normal-power mode and/or a full-power mode. In some aspects, a UE 120 may receive some downlink control messages, such as PDCCH communications and/or DCI messages, that are multiplexed with an SPS downlink communication, such as an SPS PDSCH transmission. In this way, when the UE 120 wakes up to monitor and/or decode the SPS PDSCH transmission, the UE 120 may also receive a control message (for example, a DCI message) that the UE 120 would otherwise be required to wake up and receive on a separate occasion. As a result, the UE 120 may reduce an quantity of times that the UE 120 wakes up from a reduced-power mode to receive control signaling and/or the UE 120 may reduce an overall amount of time that the UE 120 spends in a full-power mode, thereby reducing power consumption at the UE 120 and/or reducing signaling overhead associated with downlink control messages, thus conserving power, computing, and network resources otherwise consumed during traditional control signaling.

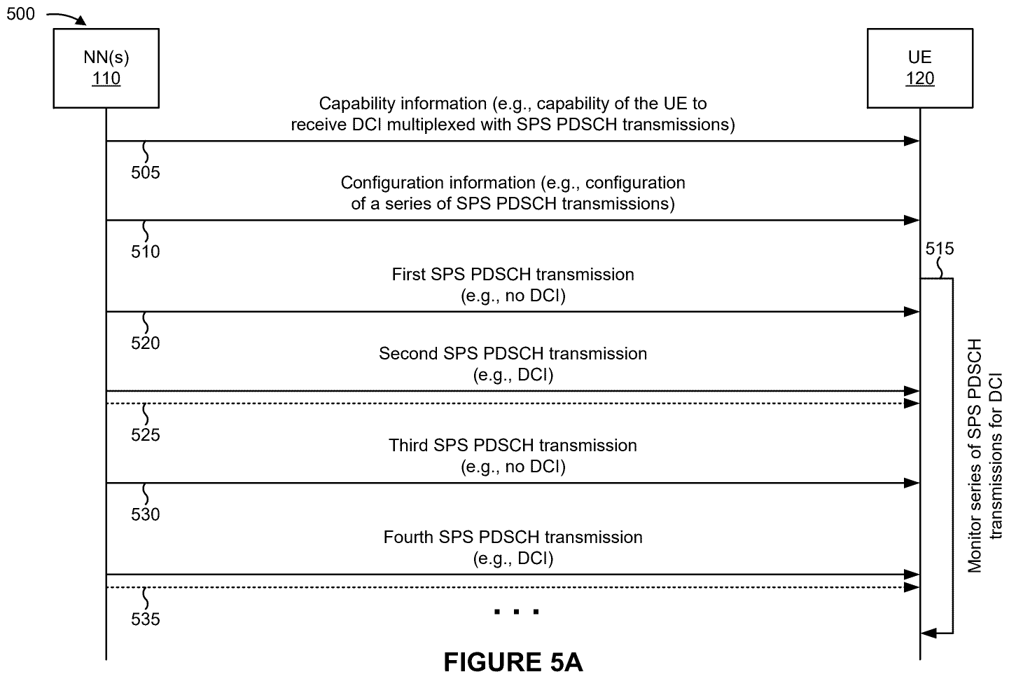

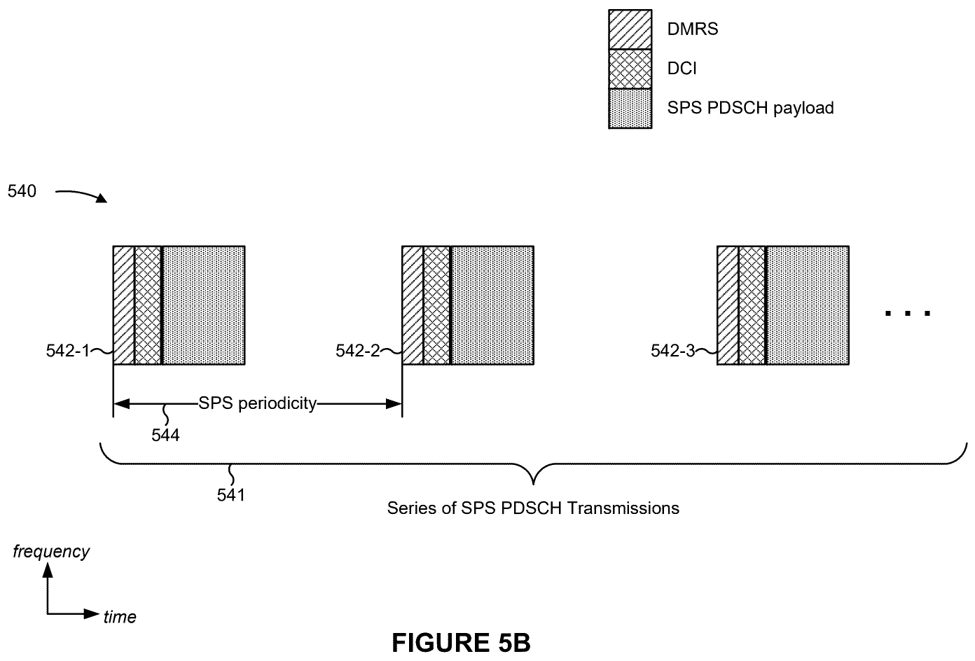

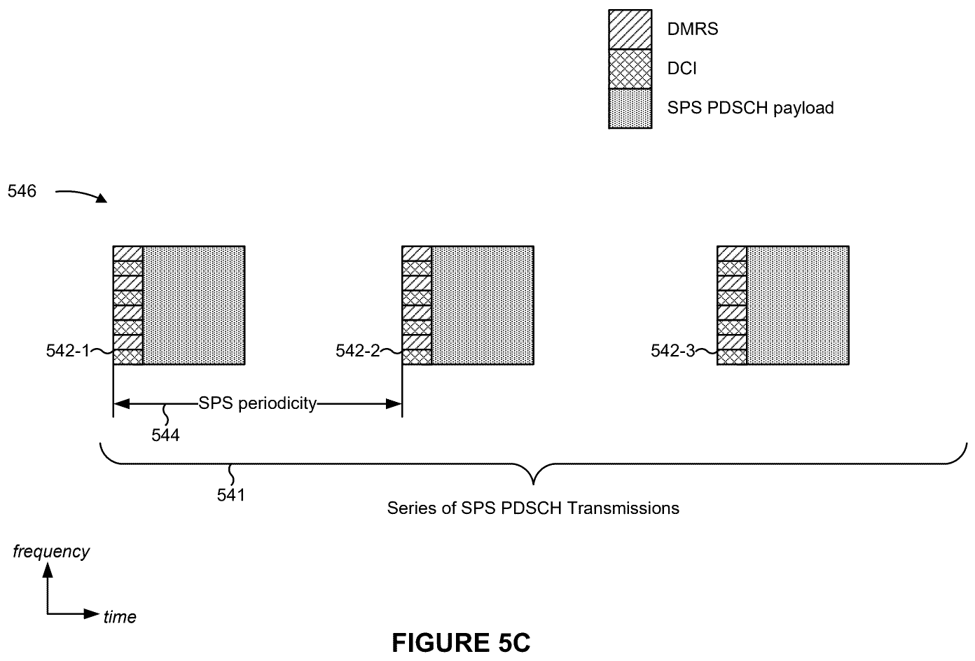

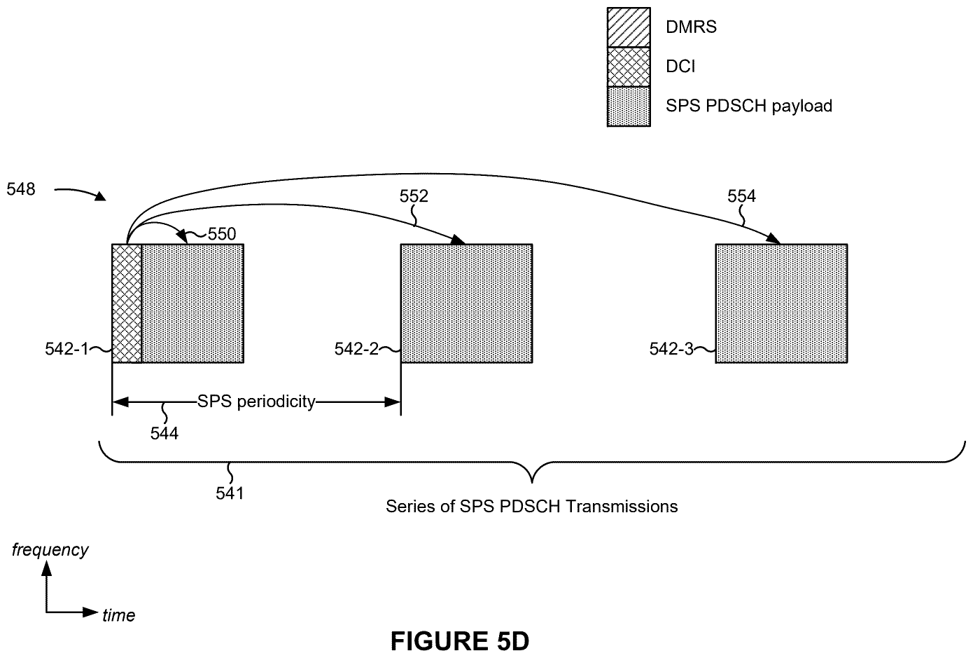

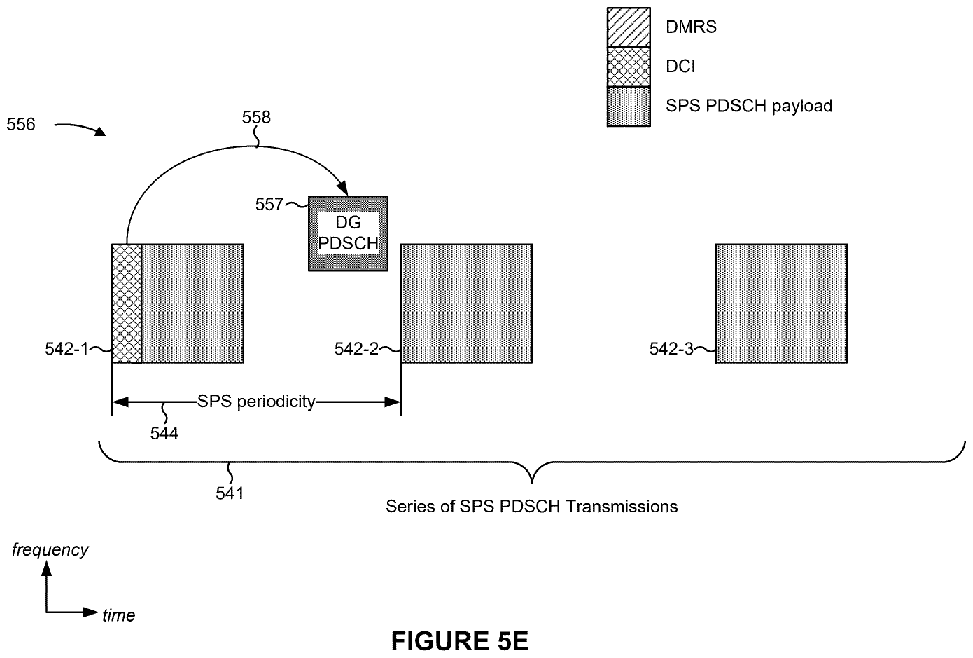

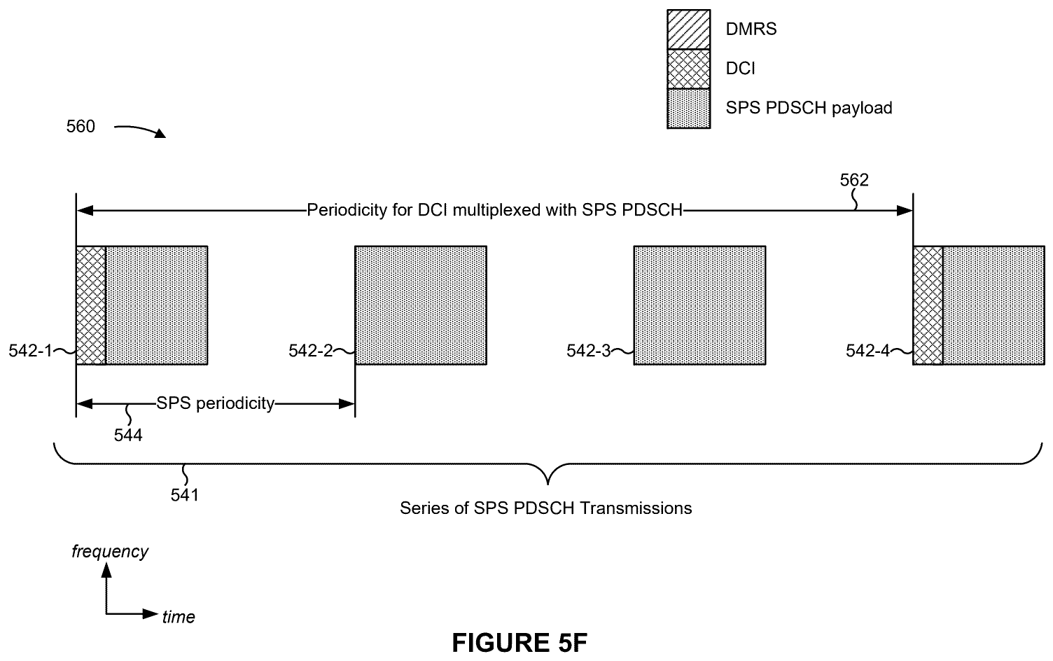

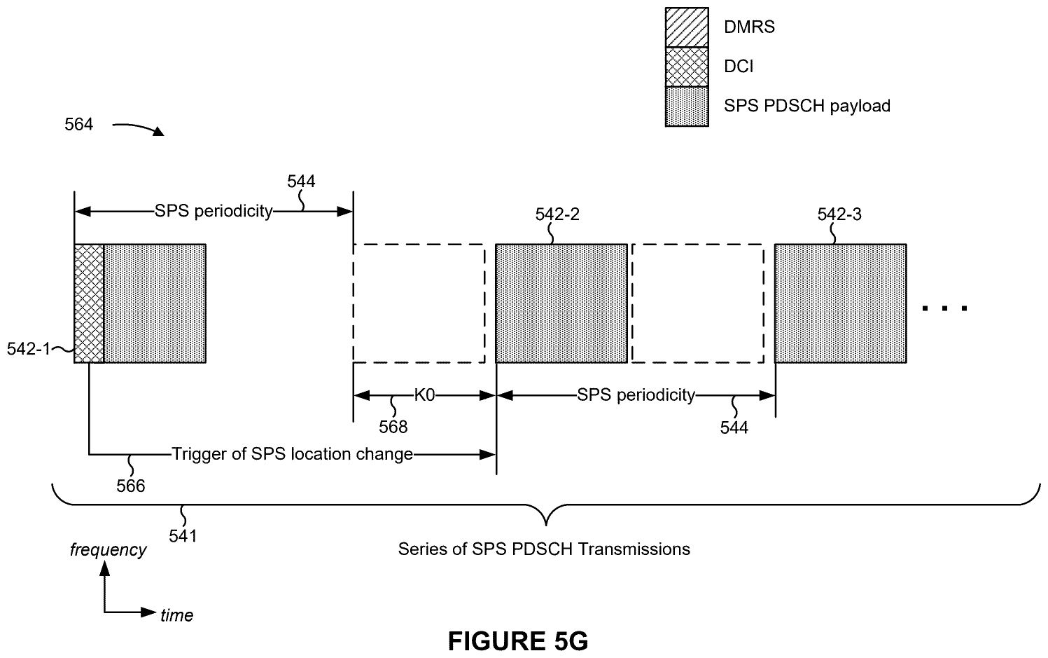

FIGS. 5A-5G are diagrams of examples associated with DCI multiplexed with an SPS PDSCH transmission, in accordance with the present disclosure. As shown in FIG. 5A. and by example 500, a network node 110 (for example, a CU, a DU, and/or an RU) may communicate with a UE 120. In some aspects, the network node 110 and the UE 120 may be part of a wireless network (for example, wireless communication network 100). The UE 120 and the network node 110 may have established a wireless connection prior to operations shown in FIG. 5A.

In a first operation 505, the UE 120 may transmit, and the network node 110 may receive, capability information (for example, a capabilities report). The capability information may indicate whether the UE 120 supports a feature and/or one or more parameters related to the feature. For example, the capability information may indicate a capability and/or parameter for receiving DCI multiplexed with an SPS PDSCH transmission. One or more operations described herein may be based on or otherwise associated with capability information. For example, the UE 120 may perform a communication in accordance with the capability information, or may receive configuration information that is in accordance with the capability information. In some aspects, the capability information may indicate UE 120 support for monitoring a series of SPS PDSCH transmissions for multiplexed DCI and/or receiving one or more DCI messages multiplexed with one or more SPS PDSCH transmissions in the series of SPS PDSCH transmissions, among other examples.

In a second operation 510, the network node 110 may transmit, and the UE 120 may receive, configuration information. In some aspects, the UE 120 may receive the configuration information via one or more of system information (for example, a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC CEs and/or one or more DCI messages, among other examples.

In some aspects, the configuration information may configure a series of SPS PDSCH transmissions, such as a series of the SPS occasions 405 described above in connection with FIG. 4 and/or the series of SPS PDSCH transmissions 541 described in more detail below in connection with FIGS. 5B-5G. Additionally or alternatively, in some aspects, the configuration information may indicate that the UE 120 is to monitor the series of SPS PDSCH transmissions for DCI. Put another way, because the UE 120 may need to wake up (for example, exit a reduced-power mode) to monitor and/or decode the series of SPS PDSCH transmissions following a specific periodicity, the network node 110 may multiplex DCI (for example, PDCCH transmissions) with one or more SPS PDSCH transmissions of the series of SPS PDSCH transmissions, such as for a purpose of reducing the UE 120's wake up time and/or reducing a quantity of occasions for which the UE 120 needs to wake up and/or exit a reduced-power mode to receive control signaling, among other examples. That is, by multiplexing DCI with the series of SPS PDSCH transmissions, the network node 110 may eliminate standalone DCI transmissions (for example, standalone PDCCH transmissions) and/or the UE 120 may reduce power consumption associated with DCI and/or PDCCH transmissions.

The UE 120 may configure itself based at least in part on the configuration information. In some aspects, the UE 120 may be configured to perform one or more operations described herein based at least in part on the configuration information.

In some aspects, the capability information described above in connection with the first operation 505 and/or the configuration information described in connection with the second operation 510 may include information transmitted via multiple communications. Additionally or alternatively, the network node 110 may transmit the configuration information, or a communication including at least a portion of the configuration information, before and/or after the UE 120 transmits the capability information. For example, the network node 110 may transmit a first portion of the configuration information before the capability information, the UE 120 may transmit at least a portion of the capability information, and the network node 110 may transmit a second portion of the configuration information after receiving the capability information.

In a third operation 515, the UE 120 may monitor the series of SPS PDSCH transmissions for DCI in accordance with the configuration information (for example, the configuration information described above in connection with the second operation 510). That is, the UE 120 may monitor the series of SPS PDSCH transmissions for one or more DCI messages multiplexed with one or more SPS PDSCH transmissions of the series of SPS PDSCH transmissions.

In some aspects, the network node 110 may transmit, and the UE 120 may receive, a DCI message multiplexed with an SPS PDSCH transmission of the series of SPS PDSCH transmissions. More particularly, as shown in connection with a fourth operation 520, a fifth operation 525, a sixth operation 530, and a seventh operation 535, the network node 110 may transmit, and the UE 120 may receive, one or more SPS PDSCH transmissions associated with the series of SPS PDSCH transmissions, such as a first SPS PDSCH transmission (via the fourth operation 520), a second SPS PDSCH transmission (via the fifth operation 525), a third SPS PDSCH transmission (via the sixth operation 530), and/or a fourth SPS PDSCH transmission (via the seventh operation 535), and so forth. Moreover, at least one SPS PDSCH transmission, of the series of SPS PDSCH transmissions, may be multiplexed with DCI. For example, in the example 500, the second SPS PDSCH transmission and the fourth SPS PDSCH transmission are multiplexed with DCI, but, in some other aspects, more or less SPS PDSCH transmissions (for example, every SPS PDSCH transmission or every third SPS PDSCH transmission, among other examples) may be multiplexed with DCI. Accordingly, for the SPS PDSCH transmissions that are multiplexed with DCI (for example, the second SPS PDSCH transmission and the fourth SPS PDSCH transmission in example 500), the UE 120 may receive a corresponding DCI message multiplexed with the SPS PDSCH transmission. Aspects of multiplexing DCI with one or more SPS PDSCH transmissions are described in more detail in connection with FIGS. 5B-5G.

First, as shown in FIG. 5B, and by example 540, in some aspects the UE 120 may receive both a DMRS and a DCI message multiplexed with an SPS transmission. More particularly, the example 540 shows a series of SPS PDSCH transmissions 541, with three separate SPS PDSCH transmissions 542 of the series SPS PDSCH transmissions 541 shown in FIG. 5B (indexed as a first SPS PDSCH transmission 542-1 through a third SPS PDSCH transmission 542-3), but which may include more or fewer SPS PDSCH transmissions 542 in other aspects. The series of SPS PDSCH transmissions 541 may be associated with an SPS periodicity 544 (for example, the UE 120 may be configured to receive the series of SPS PDSCH transmissions 541 such that the various SPS PDSCH transmissions 542 are spaced apart from one another, in the time domain, in accordance with the SPS periodicity 544). In some aspects, and as shown by example 540, an SPS PDSCH transmission 542 may include a DMRS (shown using hatching in example 540), a DCI message (shown using cross-hatching in example 540), and/or an SPS PDSCH payload (for example, a data portion of the SPS PDSCH transmission 542, shown using stippling in example 540), among other examples.

In such aspects, a location of the DCI message in an SPS PDSCH transmission 542 may be either localized or distributed. For example, the example 540 shows a localized DCI message in each SPS PDSCH transmission 542 in which the DCI message is located in a symbol (for example, an OFDM symbol) immediately following a symbol including the DMRS. such as for a purpose of enabling a best possible channel estimation procedure for the DCI message. Put another way, in some aspects, the UE 120 may receive a DMRS and a DCI message multiplexed with an SPS PDSCH transmission 542, such as by receiving the DMRS in a first set of one or more symbols associated with the SPS PDSCH transmission 542, and by receiving the DCI message in a second set of one or more symbols associated with the SPS PDSCH transmission that immediately follows the first set of one or more symbols. In some other aspects, the DCI message may be located elsewhere in the SPS PDSCH transmission 542 (for example, a location other than a symbol immediately following the DMRS), and/or an SPS PDSCH transmission 542 may include multiple DMRSs and/or multiple DCI messages distributed throughout the symbols associated with the SPS PDSCH transmission 542.

Additionally or alternatively, in some aspects a DCI message may be frequency-division multiplexed with a DMRS in an SPS PDSCH transmission 542. For example, FIG. 5C shows an example 546 in which a DCI message is frequency-division multiplexed with a DMRS in each SPS PDSCH transmission 542 of the series of SPS PDSCH transmissions 541. In this aspect, the DMRS may be a comb-based DMRS, and the DCI message may be multiplexed with the SPS PDSCH transmission 542 by inserting DCI in another comb on a DMRS symbol or a DMRS set of symbols. Put another way, in some aspects the UE 120 may receive a DMRS and a DCI message in an SPS PDSCH transmission 542, such as by receiving the DMRS in a set of one or more symbols associated with the SPS PDSCH transmission 542. with the DMRS being frequency-division multiplexed in the set of one or more symbols in accordance with a first comb pattern, and by also receiving the DCI message in the set of one or more symbols, with the DCI message being frequency-division multiplexed in the set of one or more symbols in accordance with a second comb pattern. Moreover, although the DMRS and the DCI message are shown as being frequency-division multiplexed in a first-in-time set of one or more symbols associated with an SPS PDSCH transmission 542, in some other aspects, the DMRS and the DCI message may be located at a different location, in a time domain, within the SPS PDSCH transmission 542 (for example, the DMRS and the DCI message may be frequency-division multiplexed in a set of symbols other than a first-in-time set of one or more symbols).

In some aspects, a DCI message that is multiplexed with an SPS PDSCH transmission 542 may be used for a purpose of dynamically adjusting one or more transmission parameters associated with the series of SPS PDSCH transmissions 541. For example, as shown in FIG. 5D, and by example 548, a DCI message may be used to adjust one or more parameters associated with the series of SPS PDSCH transmissions 541. Although for ease of description no DMRSs are shown in connection with the examples depicted in FIGS. 5D-5G, in some aspects one or more of the SPS PDSCH transmissions 542 may include a DMRS, in a similar manner as described above in connection with example 540 of FIG. 5B and/or example 546 of FIG. 5C. Moreover, although for ease of description the DCI messages shown in connection with the examples depicted in FIGS. 5D-5G occur in a first-in-time set of symbols of the respective SPS PDSCH transmissions 542, in some other aspects a DCI message may be located in a different time-domain location of a respective SPS PDSCH transmission 542, in a similar manner as described above in connection with example 540 of FIG. 5B and/or example 546 of FIG. 5C.

In the example 548 shown in FIG. 5D, the first SPS PDSCH transmission 542-1 may include a multiplexed DCI message that is used to dynamically adjust transmission parameters for one or more of the SPS PDSCH transmissions 542 of the series of SPS PDSCH transmissions 541. Put another way, the DCI message multiplexed with the first SPS PDSCH transmission 542-1 may indicate one or more transmission parameters associated with one or more SPS PDSCH transmissions 542 of the series of SPS PDSCH transmissions 541. In some aspects, the transmission parameters indicated and/or dynamically adjusted by the DCI message may be associated with one or more of a new data indicator (NDI) associated with one or more SPS PDSCH transmissions 542, an MCS associated with one or more SPS PDSCH transmissions 542, a quantity of MIMO layers associated with one or more SPS PDSCH transmissions 542, a type of DMRS associated with one or more SPS PDSCH transmissions 542, a time-domain resource allocation (TDRA) associated with one or more SPS PDSCH transmissions 542, a frequency-domain resource allocation (FDRA) associated with one or more SPS PDSCH transmissions 542, and/or similar transmission parameters associated with one or more SPS PDSCH transmissions 542.

In some aspects, the DCI message may be used to adjust transmission parameters for the SPS PDSCH transmission 542 that is multiplexed with the DCI message (for example, the first SPS PDSCH transmission in the example 548), and/or the DCI message may be used to adjust transmission parameters for SPS PDSCH transmissions 542 that occur after the SPS PDSCH transmission 542 that is multiplexed with the DCI message (for example, the second SPS PDSCH transmission 542-2 and/or the third SPS PDSCH transmission 542-3, and so forth). For example, as shown by the arrow labeled with reference number 550, the DCI message multiplexed with the first SPS PDSCH transmission 542-1 may be used for a purpose of adjusting transmission parameters associated with the first SPS PDSCH transmission 542-1. However, in some other aspects, the DCI message may not be used to adjust transmission parameter of an SPS PDSCH transmission 542 that is multiplexed with the DCI message (for example, the first SPS PDSCH transmission 542-1 in example 548), such as for a purpose of accounting for a DCI and/or PDCCH decoding delay by the UE 120. Additionally or alternatively, as shown by the arrows labeled with reference numbers 552 and 554, the DCI message multiplexed with the first SPS PDSCH transmission 542-1 may be used for a purpose of adjusting transmission parameters associated with subsequent SPS PDSCH transmissions 542 (for example, SPS PDSCH transmissions 542 that occur after an SPS PDSCH transmission 542 that is multiplexed with the DCI message), such as the second SPS PDSCH transmission 542-2 and the third SPS PDSCH transmission 542-3, respectively, in the example 548.

Additionally or alternatively, in aspects in which the DCI message is used for a purpose of dynamically changing one or more transmission parameters associated with the series of SPS PDSCH transmissions 541, the DCI message may indicate which specific SPS PDSCH transmissions 542 are associated with the transmission parameters, and/or the UE 120 may be configured, preconfigured, and/or hard-coded with an indication of which specific SPS PDSCH transmissions 542 are associated with the transmission parameters indicated by the DCI message. For example, the UE 120 may be configured, preconfigured, and/or hard-coded with a decoding timeline, such as K OFDM symbols. In such aspects, the UE 120 may apply the transmission parameters indicated by the DCI message to SPS PDSCH transmissions 542 that occur at least K OFDM symbols after a last OFDM symbol carrying the DCI message. In some aspects, the UE 120 may be configured with the value of K (for example, via the configuration information described above in connection with the second operation 510 of FIG. 5A), and/or the value of K may be defined by a relevant wireless communication standard (for example, a wireless communication standard promulgated by the 3GPP).

In some other aspects, the UE 120 may apply the change in transmission parameters to SPS PDSCH transmissions 542 that occur after a HARQ ACK message that is associated with the SPS PDSCH transmission 542 in which the DCI message is received (for example, the first SPS PDSCH transmission 542-1 in example 548) is transmitted. More particularly, in some aspects the UE 120 may transmit a HARQ ACK message associated with the SPS PDSCH transmission 542 in which the DCI message is received, and the one or more SPS PDSCH transmissions for which the indicated transmission parameters apply are one or more SPS PDSCH transmissions 542 that occur after transmission of the HARQ ACK message.

In some other aspects, the SPS PDSCH transmissions 542 for which the transmission parameters apply may be explicitly indicated in the DCI message. For example, the DCI message may include a field (sometimes referred to herein as X) to indicate that the transmission parameters indicated by the DCI message are to applied to the SPS PDSCH transmission 542 carrying the DCI message (for example, the first SPS PDSCH transmission 542-1 in example 548) plus X SPS PDSCH transmissions 542 later. In such aspects, when X=0, the transmission parameters apply to the SPS PDSCH transmission 542 multiplexed with the DCI (for example, the first SPS PDSCH transmission 542-1 in example 548) as well as subsequent SPS PDSCH transmissions 542 (for example, the second SPS PDSCH transmission 542-2, the third SPS PDSCH transmission 542-3, and so forth). Similarly, when X=1, the transmission parameters apply to the SPS PDSCH transmission 542 immediately following the SPS PDSCH transmission 542 that is multiplexed with the DCI as well as subsequent SPS PDSCH transmissions 542 (for example, when X=1, the transmission parameters apply to the second SPS PDSCH transmission 542-1, the third SPS PDSCH transmission 542-3, and so forth). Additionally or alternatively, in aspects when a DCI message that is multiplexed with an SPS PDSCH transmission 542 is used for a purpose of dynamically adjusting one or more transmission parameters associated with the series of SPS PDSCH transmissions, the transmission parameters indicated by the DCI message may remain valid until the UE 120 receives a subsequent DCI message indicating a different set of transmission parameters (for example, until the transmission parameters are overridden by a future DCI message) and/or until the series of SPS PDSCH transmissions 541 is deactivated (for example, via control signaling from the network node 110, or the like).

In some other aspects, a DCI message that is multiplexed with an SPS PDSCH transmission 542 may be used for a purpose of scheduling a DG PDSCH, such as a DG PDSCH within a same component carrier (CC) as the CC in which the SPS PDSCH transmission 542 multiplexed with the DCI message is received and/or within one or more CCs other than the CC in which the SPS PDSCH transmission 542 multiplexed with the DCI message is received. For example, as shown in FIG. 5E, and by example 556, a DCI message may be used to schedule a DG PDSCH transmission 557. More particularly, in this aspect, a DCI message that is multiplexed with the first SPS PDSCH transmission 542-1 is used for a purpose of scheduling the DG PDSCH transmission 557, as shown by the arrow labeled with reference number 558. Put another way, in some aspects the DCI message that is multiplexed with an SPS PDSCH transmission 542 may indicate resources and/or transmission parameters associated with a DG PDSCH transmission 557 that is to be transmitted by the network (for example, by the network node 110) to the UE 120.

In some aspects, the DCI message that is multiplexed with an SPS PDSCH transmission 542 may indicate whether the DCI message is being used for a purpose of dynamically adjusting one or more transmission parameters associated with the series of SPS PDSCH transmissions 541 (for example, in a similar as described above in connection with example 548 of FIG. 5D) or else is being used for a purpose of scheduling a DG PDSCH transmission 557 (for example, in a similar manner as described above in connection with example 556 of FIG. 5E). For example, in some aspects, the DCI message may include a CRC that is scrambled by a configured scheduling RNTI (CS-RNTI) or else one of a cell RNTI (C-RNTI) or a temporary cell RNTI (TC-RNTI). In such aspects, the network node 110 may scramble the CRC by the CS-RNTI to indicate that the DCI message is being used for a purpose of dynamically adjusting one or more transmission parameters associated with the series of SPS PDSCH transmissions 541, and/or the network node 110 may scramble the CRC by the one of the C-RNTI or the TC-RNTI to indicate that the DCI message is being used for a purpose of scheduling a DG PDSCH transmission 557. Put another way, in some aspects, the UE 120 may identify that the DCI message indicates one or more transmission parameters associated with one or more SPS PDSCH transmissions 542 by identifying that a CRC associated with the DCI message is scrambled by a CS-RNTI, and/or the UE 120 may identify that the DCI message schedules the DG PDSCH transmission 557 by identifying that the CRC associated with the DCI message is scrambled by one of a C-RNTI or a TC-RNTI.

In some aspects, DCI may be multiplexed with less than all of the SPS PDSCH transmissions 542 in the series of SPS PDSCH transmissions 541. In such aspects, the UE 120 may be configured with a periodicity in which to expect a DCI message multiplexed with an SPS PDSCH transmission 542, such as for a purpose of enabling the UE 120 to avoid blind decoding of each SPS PDSCH transmission 542 in order to determine whether the SPS PDSCH transmission 542 includes a DCI message. For example, as shown in FIG. 5F, and as indicated by example 560, the UE 120 may be configured with a periodicity for DCI being multiplexed with an SPS PDSCH transmission 542, sometimes referred to herein simply as a DCI periodicity 562. More particularly, the network node 110 may transmit, and the UE 120 may receive, configuration information (for example, the configuration information described above in connection with the second operation 510 in FIG. 5A) that configures a periodicity (for example, the DCI periodicity 562) for including one or more DCI messages in a subset of SPS PDSCH transmissions 542 of the series of SPS PDSCH transmissions 541, and thus the UE 120 may monitor the series of SPS PDSCH transmissions 541 for DCI in accordance with the periodicity. In aspects in which less than all of the SPS PDSCH transmissions 542 are to be multiplexed with a DCI message, such as the first SPS PDSCH transmission 542-1 and a fourth SPS PDSCH transmission 542-4 as shown in example 560, the DCI periodicity 562 may be longer than the SPS periodicity 544. More particularly, in aspects in which a DCI message is to be multiplexed with every third SPS PDSCH transmission 542 (as shown in example 560), the DCI periodicity 562 may be three times the SPS periodicity 544.

Additionally or alternatively, in some aspects a DCI message that is multiplexed with an SPS PDSCH transmission 542 may be used to indicate a change in a time-domain location of one or more subsequent SPS PDSCH transmissions 542 of the series of SPS PDSCH transmissions 541. More particularly, as shown in FIG. 5G, and as indicated by example 564, in this aspect a DCI message that is multiplexed with the first SPS PDSCH transmission 542-1 may be used to change a time-domain location of the second SPS PDSCH transmission 542-2 and subsequent SPS PDSCH transmissions 542. More particularly, the DCI message multiplexed with the first SPS PDSCH transmission 542-1 may trigger a time-domain location change (for example, an offset) of the second SPS PDSCH transmission 542-2 (for example, the DCI message may indicate a new time-domain location of the second SPS PDSCH transmission 542-2), as shown by the arrow labeled with reference number 566. The remaining SPS PDSCH transmissions 542 (for example, the third SPS PDSCH transmission 542-3 and subsequent SPS PDSCH transmissions 542) may similarly shift, in the time domain, the indicated offset, such that the SPS periodicity 544 is maintained between the subsequent SPS PDSCH transmissions 542 of the series of SPS PDSCH transmissions 541.

In some aspects, the DCI message that is multiplexed with the SPS PDSCH transmission 542 may indicate the change in the time-domain location of the subsequent SPS PDSCH transmission 542 using a K0 field of a PDSCH TDRA (for example, a K0 field of a PDSCH-TimeDomainAllocationList information element (IE) and/or a similar TDRA). More particularly, as shown in example 564, and as indicated by the arrow labeled with reference number 568, the K0 field may be used to indicate a time-domain offset (for example, a slot offset) between an originally configured time-domain location of the next SPS PDSCH transmission 542 (for example, the second SPS PDSCH transmission 542-2 in the example 564) and the new time-domain location of the next SPS PDSCH transmission 542. In such aspects, when the K0 value is positive (for example, when K0>0), the time-domain location of the subsequent SPS PDSCH transmissions 542 may be shifted later in the time domain, as shown in the example 564. Alternatively, when the K0 value is negative (for example, when K0<0), the time-domain location of the subsequent SPS PDSCH transmissions 542 may be shifted earlier in the time domain. Put another way, a positive offset value (for example, K0>0) may indicate a move of the SPS PDSCH transmission 542 to a later time-domain location with respect to the originally configured time domain location, and/or a negative offset value (for example, K0<0) may indicate a move of the SPS PDSCH transmission 542 to an earlier time-domain location with respect to the originally configured time domain location.

Based at least in part on the UE 120 receiving one or more DCI messages multiplexed with one or more SPS PDSCH transmissions 542 of a series of SPS PDSCH transmissions 541. the UE 120 and/or the network node 110 may conserve computing, power, network, and/or communication resources that may have otherwise been consumed by using traditional DCI signaling. For example, based at least in part on the UE 120 receiving one or more DCI messages multiplexed with one or more SPS PDSCH transmissions 542 of a series of SPS PDSCH transmissions 541, the UE 120 may reduce a quantity of times that the UE 120 wakes up from a reduced-power mode to receive DCI and/or the UE 120 may reduce an amount of wake-up time during which the UE 120 is in a full-power mode to receive DCI, thereby reducing power consumption and otherwise conserving power, computing, and network resources otherwise consumed by the UE 120 frequently waking up to receive downlink messages.

FIG. 6 is a flowchart illustrating an example process 600 performed, for example, at a UE or an apparatus of a UE that supports a series of SPS PDSCH transmissions in accordance with the present disclosure. Example process 600 is an example where the apparatus or the UE (for example, UE 120) performs operations associated with multiplexing DCI with an SPS PDSCH transmission.

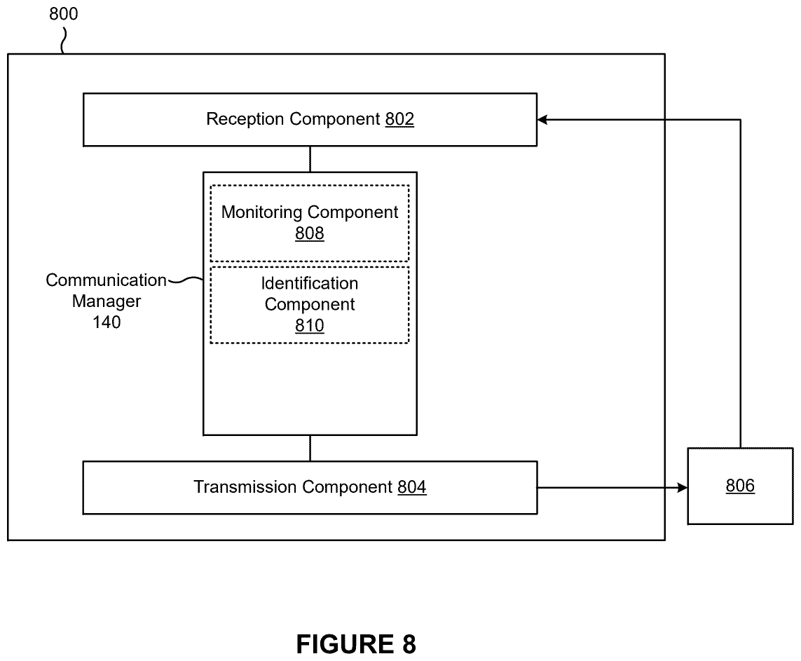

As shown in FIG. 6, in some aspects, process 600 may include receiving configuration information that configures a series of SPS PDSCH transmissions (block 610). For example, the UE (such as by using communication manager 140 or reception component 802, depicted in FIG. 8) may receive configuration information that configures a series of SPS PDSCH transmissions, as described above.

As further shown in FIG. 6, in some aspects, process 600 may include monitoring the series of SPS PDSCH transmissions for DCI in accordance with the configuration information (block 620). For example, the UE (such as by using communication manager 140 or monitoring component 808, depicted in FIG. 8) may monitor the series of SPS PDSCH transmissions for DCI in accordance with the configuration information, as described above.

As further shown in FIG. 6, in some aspects, process 600 may include receiving a DCI message multiplexed with an SPS PDSCH transmission of the series of SPS PDSCH transmissions (block 630). For example, the UE (such as by using communication manager 140 or reception component 802, depicted in FIG. 8) may receive a DCI message multiplexed with an SPS PDSCH transmission of the series of SPS PDSCH transmissions, as described above.

Process 600 may include additional aspects, such as any single aspect or any combination of aspects described below or in connection with one or more other processes described elsewhere herein.

In a first additional aspect, process 600 includes receiving a DMRS in the SPS PDSCH transmission, wherein the DMRS is received in a first set of one or more symbols associated with the SPS PDSCH transmission, wherein the DCI message is received in a second set of one or more symbols associated with the SPS PDSCH transmission, and wherein the second set of one or more symbols immediately follows the first set of one or more symbols.

In a second additional aspect, alone or in combination with the first aspect, process 600 includes receiving a DMRS in the SPS PDSCH transmission, wherein the DMRS is received in a set of one or more symbols associated with the SPS PDSCH transmission and is frequency-division multiplexed in the set of one or more symbols in accordance with a first comb pattern, and wherein the DCI message is frequency-division multiplexed in the set of one or more symbols in accordance with a second comb pattern.

In a third additional aspect, alone or in combination with one or more of the first and second aspects, the DCI message indicates one or more transmission parameters associated with one or more SPS PDSCH transmissions of the series of SPS PDSCH transmissions.

In a fourth additional aspect, alone or in combination with one or more of the first through third aspects, process 600 includes receiving configuration information that configures a periodicity for including one or more DCI messages in a subset of SPS PDSCH transmissions of the series of SPS PDSCH transmissions, wherein monitoring the series of SPS PDSCH transmissions for DCI is in accordance with the periodicity.

In a fifth additional aspect, alone or in combination with one or more of the first through fourth aspects, the DCI message indicates a change in a time-domain location of a subsequent SPS PDSCH transmission of the series of SPS PDSCH transmissions.

In a sixth additional aspect, alone or in combination with one or more of the first through fifth aspects, the DCI message indicates the change in the time-domain location of the subsequent SPS PDSCH transmission using a KO field of a PDSCH time domain resource allocation.

In a seventh additional aspect, alone or in combination with one or more of the first through sixth aspects, process 600 includes transmitting a HARQ ACK message associated with the SPS PDSCH transmission, wherein the one or more SPS PDSCH transmissions are one or more SPS PDSCH transmissions that occur after transmission of the HARQ ACK message.

In an eighth additional aspect, alone or in combination with one or more of the first through seventh aspects, the DCI message schedules a dynamic grant PDSCH.

In a ninth additional aspect, alone or in combination with one or more of the first through eighth aspects, process 600 includes identifying whether the DCI message indicates one or more transmission parameters associated with one or more SPS PDSCH transmissions of the series of SPS PDSCH transmissions, or schedules a dynamic grant PDSCH.

In a tenth additional aspect, alone or in combination with one or more of the first through ninth aspects, process 600 includes at least one of identifying that the DCI message indicates the one or more transmission parameters associated with the one or more SPS PDSCH transmissions by identifying that a CRC associated with the DCI message is scrambled by a configured scheduling RNTI, or identifying that the DCI message schedules the dynamic grant PDSCH by identifying that the CRC associated with the DCI message is scrambled by one of a cell RNTI or a temporary cell RNTI.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a flowchart illustrating an example process 700 performed, for example, at a network node or an apparatus of a network node that supports a series of SPS PDSCH transmissions in accordance with the present disclosure. Example process 700 is an example where the apparatus or the network node (for example, network node 110) performs operations associated with multiplexing DCI with an SPS PDSCH transmission.

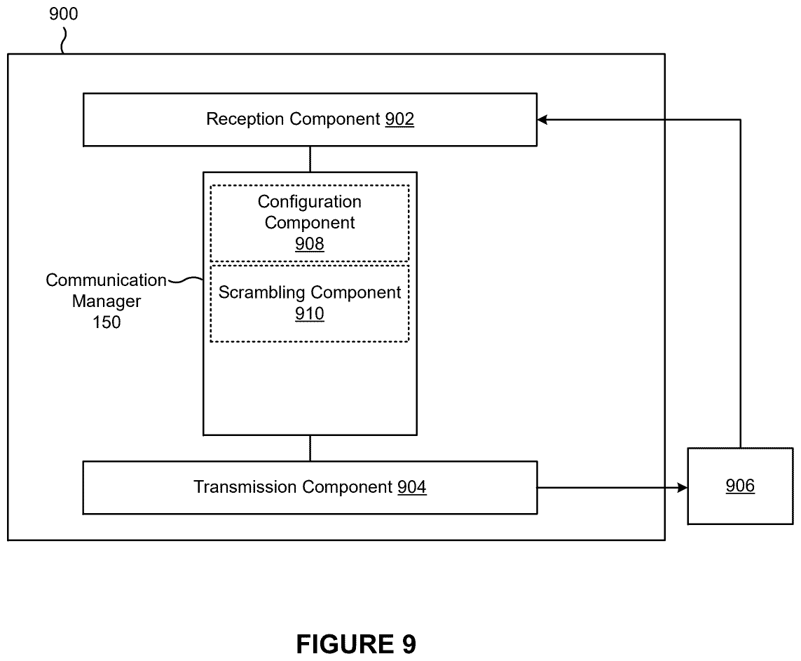

As shown in FIG. 7, in some aspects, process 700 may include transmitting, to a UE, configuration information that configures a series of SPS PDSCH transmissions (block 710). For example, the network node (such as by using communication manager 150 or transmission component 904, depicted in FIG. 9) may transmit, to a UE, configuration information that configures a series of SPS PDSCH transmissions, as described above.

As further shown in FIG. 7, in some aspects, process 700 may include transmitting, to the UE, a DCI message multiplexed with an SPS PDSCH transmission of the series of SPS PDSCH transmissions in accordance with the configuration information (block 720). For example, the network node (such as by using communication manager 150 or transmission component 904, depicted in FIG. 9) may transmit, to the UE, a DCI message multiplexed with an SPS PDSCH transmission of the series of SPS PDSCH transmissions in accordance with the configuration information, as described above.

Process 700 may include additional aspects, such as any single aspect or any combination of aspects described below or in connection with one or more other processes described elsewhere herein.

In a first additional aspect, process 700 includes transmitting, to the UE, a DMRS in the SPS PDSCH transmission, wherein the DMRS is transmitted in a first set of one or more symbols associated with the SPS PDSCH transmission, wherein the DCI message is transmitted in a second set of one or more symbols associated with the SPS PDSCH transmission, and wherein the second set of one or more symbols immediately follows the first set of one or more symbols.

In a second additional aspect, alone or in combination with the first aspect, process 700 includes transmitting, to the UE, a DMRS in the SPS PDSCH transmission, wherein the DMRS is transmitted in a set of one or more symbols associated with the SPS PDSCH transmission and is frequency-division multiplexed in the set of one or more symbols in accordance with a first comb pattern, and wherein the DCI message is frequency-division multiplexed in the set of one or more symbols in accordance with a second comb pattern.

In a third additional aspect, alone or in combination with one or more of the first and second aspects, the DCI message indicates one or more transmission parameters associated with one or more SPS PDSCH transmission of the series of SPS PDSCH transmissions.

In a fourth additional aspect, alone or in combination with one or more of the first through third aspects, process 700 includes transmitting, to the UE, configuration information that configures a periodicity for including one or more DCI messages in a subset of SPS PDSCH transmissions of the series of SPS PDSCH transmissions.

In a fifth additional aspect, alone or in combination with one or more of the first through fourth aspects, the DCI message indicates a change in a time-domain location of a subsequent SPS PDSCH transmission of the series of SPS PDSCH transmissions.

In a sixth additional aspect, alone or in combination with one or more of the first through fifth aspects, the DCI message indicates the change in the time-domain location of the subsequent SPS PDSCH transmission using a K0 field of a PDSCH time domain resource allocation.

In a seventh additional aspect, alone or in combination with one or more of the first through sixth aspects, process 700 includes receiving, from the UE, a HARQ ACK message associated with the SPS PDSCH transmission, wherein the one or more SPS PDSCH transmissions are one or more SPS PDSCH transmissions that occur after transmission of the HARQ ACK message.

In an eighth additional aspect, alone or in combination with one or more of the first through seventh aspects, the DCI message schedules a dynamic grant PDSCH.

In a ninth additional aspect, alone or in combination with one or more of the first through eighth aspects, process 700 includes at least one of scrambling a CRC associated with the DCI message by a CS-RNTI, wherein scrambling the CRC by the CS-RNTI indicates that the DCI message indicates one or more transmission parameters associated with one or more SPS PDSCH transmissions of the series of SPS PDSCH transmissions, or scrambling the CRC by one of a C-RNTI or a TC-RNTI, wherein scrambling the CRC by the one of the C-RNTI or the TC-RNTI indicates that the DCI schedules a dynamic grant PDSCH.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram of an example apparatus 800 for wireless communication that supports DCI multiplexed with SPS PDSCH transmissions in accordance with the present disclosure. The apparatus 800 may be a UE 120, or a UE 120 may include the apparatus 800. In some aspects, the apparatus 800 includes a reception component 802, a transmission component 804, and a communication manager 140, which may be in communication with one another (for example, via one or more buses). As shown, the apparatus 800 may communicate with another apparatus 806 (such as a UE 120, a network node 110, or another wireless communication device) using the reception component 802 and the transmission component 804.

In some aspects, the apparatus 800 may be configured to and/or operable to perform one or more operations described herein in connection with FIGS. 5A-5G. Additionally or alternatively, the apparatus 800 may be configured to and/or operable to perform one or more processes described herein, such as process 600 of FIG. 6. In some aspects, the apparatus 800 may include one or more components of the UE 120 described above in connection with FIG. 1 and FIG. 2.

The reception component 802 may receive communications, such as reference signals, control information, and/or data communications, from the apparatus 806. The reception component 802 may transmit received communications to one or more other components of the apparatus 800, such as the communication manager 140. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may transmit the processed signals to the one or more other components. In some aspects, the reception component 802 may include one or more antennas, one or more modems, one or more demodulators, one or more MIMO detectors, one or more receive processors, one or more controllers/processors, and/or one or more memories of the UE 120 described above in connection with FIG. 1 and FIG. 2.

The transmission component 804 may transmit communications, such as reference signals, control information, and/or data communications, to the apparatus 806. In some aspects, the communication manager 140 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, one or more modems, one or more modulators, one or more transmit MIMO processors, one or more transmit processors, one or more controllers/processors, and/or one or more memories of the UE 120 described above in connection with FIG. 1 and FIG. 2. In some aspects, the transmission component 804 may be co-located with the reception component 802 in one or more transceivers.

The communication manager 140 may receive or may cause the reception component 802 to receive configuration information that configures a series of SPS PDSCH transmissions. The communication manager 140 may monitor the series of SPS PDSCH transmissions for DCI in accordance with the configuration information. The communication manager 140 may receive or may cause the reception component 802 to receive a DCI message multiplexed with an SPS PDSCH transmission of the series of SPS PDSCH transmissions. In some aspects, the communication manager 140 may perform one or more operations described elsewhere herein as being performed by one or more components of the communication manager 140.

The communication manager 140 may include one or more controllers/processors and/or one or more memories of the UE 120 described above in connection with FIG. 1 and FIG. 2. In some aspects, the communication manager 140 includes a set of components, such as a monitoring component 808 and/or an identification component 810. Alternatively, the set of components may be separate and distinct from the communication manager 140. In some aspects, one or more components of the set of components may include or may be implemented within one or more controllers/processors and/or one or more memories of the UE 120 described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive configuration information that configures a series of SPS PDSCH transmissions. The monitoring component 808 may monitor the series of SPS PDSCH transmissions for DCI in accordance with the configuration information. The reception component 802 may receive a DCI message multiplexed with an SPS PDSCH transmission of the series of SPS PDSCH transmissions.

The reception component 802 may receive a DMRS in the SPS PDSCH transmission, wherein the DMRS is received in a first set of one or more symbols associated with the SPS PDSCH transmission, wherein the DCI message is received in a second set of one or more symbols associated with the SPS PDSCH transmission, and wherein the second set of one or more symbols immediately follows the first set of one or more symbols.

The reception component 802 may receive a DMRS in the SPS PDSCH transmission, wherein the DMRS is received in a set of one or more symbols associated with the SPS PDSCH transmission and is frequency-division multiplexed in the set of one or more symbols in accordance with a first comb pattern, and wherein the DCI message is frequency-division multiplexed in the set of one or more symbols in accordance with a second comb pattern.

The reception component 802 may receive configuration information that configures a periodicity for including one or more DCI messages in a subset of SPS PDSCH transmissions of the series of SPS PDSCH transmissions, wherein monitoring the series of SPS PDSCH transmissions for DCI is in accordance with the periodicity.

The transmission component 804 may transmit a HARQ ACK message associated with the SPS PDSCH transmission, wherein the one or more SPS PDSCH transmissions are one or more SPS PDSCH transmissions that occur after transmission of the HARQ ACK message.

The identification component 810 may identify whether the DCI message indicates one or more transmission parameters associated with one or more SPS PDSCH transmissions of the series of SPS PDSCH transmissions, or schedules a dynamic grant PDSCH.

The quantity and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

FIG. 9 is a diagram of an example apparatus 900 for wireless communication that supports DCI multiplexed with SPS PDSCH transmissions in accordance with the present disclosure. The apparatus 900 may be a network node 110, or a network node 110 may include the apparatus 900. In some aspects, the apparatus 900 includes a reception component 902, a transmission component 904, and a communication manager 150, which may be in communication with one another (for example, via one or more buses). As shown, the apparatus 900 may communicate with another apparatus 906 (such as a UE 120, a network node 110, or another wireless communication device) using the reception component 902 and the transmission component 904.

In some aspects, the apparatus 900 may be configured to and/or operable to perform one or more operations described herein in connection with FIGS. 5A-5G. Additionally or alternatively, the apparatus 900 may be configured to and/or operable to perform one or more processes described herein, such as process 700 of FIG. 7. In some aspects, the apparatus 900 may include one or more components of the network node 110 described above in connection with FIG. 1 and FIG. 2.

The reception component 902 may receive communications, such as reference signals, control information, and/or data communications, from the apparatus 906. The reception component 902 may transmit received communications to one or more other components of the apparatus 900, such as the communication manager 150. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may transmit the processed signals to the one or more other components. In some aspects, the reception component 902 may include one or more antennas, one or more modems, one or more demodulators, one or more MIMO detectors, one or more receive processors, one or more controllers/processors, and/or one or more memories of the network node 110 described above in connection with FIG. 1 and FIG. 2.

The transmission component 904 may transmit communications, such as reference signals, control information, and/or data communications, to the apparatus 906. In some aspects, the communication manager 150 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, one or more modems, one or more modulators, one or more transmit MIMO processors, one or more transmit processors, one or more controllers/processors, and/or one or more memories of the network node 110 described above in connection with FIG. 1 and FIG. 2. In some aspects, the transmission component 904 may be co-located with the reception component 902 in one or more transceivers.

The communication manager 150 may transmit or may cause the transmission component 904 to transmit, to a UE, configuration information that configures a series of SPS PDSCH transmissions. The communication manager 150 may transmit or may cause the transmission component 904 to transmit, to the UE, a DCI message multiplexed with an SPS PDSCH transmission of the series of SPS PDSCH transmissions in accordance with the configuration information. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node 110 described above in connection with FIG. 1 and FIG. 2. In some aspects, the communication manager 150 includes a set of components, such as a configuration component 908, and/or a scrambling component 910. Alternatively, the set of components may be separate and distinct from the communication manager 150. In some aspects, one or more components of the set of components may include or may be implemented within one or more controllers/processors, one or more memories, one or more schedulers, and/or one or more communication units of the network node 110 described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 904 and/or the configuration component 908 may transmit, to a UE, configuration information that configures a series of SPS PDSCH transmissions. The transmission component 904 may transmit, to the UE, a DCI message multiplexed with an SPS PDSCH transmission of the series of SPS PDSCH transmissions in accordance with the configuration information.

The transmission component 904 may transmit, to the UE, a DMRS in the SPS PDSCH transmission wherein the DMRS is transmitted in a first set of one or more symbols associated with the SPS PDSCH transmission, wherein the DCI message is transmitted in a second set of one or more symbols associated with the SPS PDSCH transmission, and wherein the second set of one or more symbols immediately follows the first set of one or more symbols.

The transmission component 904 may transmit, to the UE, a DMRS in the SPS PDSCH transmission wherein the DMRS is transmitted in a set of one or more symbols associated with the SPS PDSCH transmission and is frequency-division multiplexed in the set of one or more symbols in accordance with a first comb pattern, and wherein the DCI message is frequency-division multiplexed in the set of one or more symbols in accordance with a second comb pattern.

The transmission component 904 and/or the configuration component 908 may transmit, to the UE, configuration information that configures a periodicity for including one or more DCI messages in a subset of SPS PDSCH transmissions of the series of SPS PDSCH transmissions.

The reception component 902 may receive, from the UE, a HARQ ACK message associated with the SPS PDSCH transmission, wherein the one or more SPS PDSCH transmissions are one or more SPS PDSCH transmissions that occur after transmission of the HARQ ACK message.

The scrambling component 910 may scramble a CRC associated with the DCI message by a CS-RNTI, wherein scrambling the CRC by the CS-RNTI indicates that the DCI message indicates one or more transmission parameters associated with one or more SPS PDSCH transmissions of the series of SPS PDSCH transmissions.

The scrambling component 910 may scramble the CRC by one of a C-RNTI or a TC-RNTI, wherein scrambling the CRC by the one of the C-RNTI or the TC-RNTI indicates that the DCI schedules a dynamic grant PDSCH.

The quantity and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some Aspects of the present disclosure:
Aspect 1: A method for wireless communication by a user equipment (UE), comprising: receiving configuration information that configures a series of semi-persistent scheduling (SPS) physical downlink shared channel (PDSCH) transmissions; monitoring the series of SPS PDSCH transmissions for downlink control information (DCI) in accordance with the configuration information; and receiving a DCI message multiplexed with an SPS PDSCH transmission of the series of SPS PDSCH transmissions.
Aspect 2: The method of Aspect 1, further comprising receiving a demodulation reference signal (DMRS) in the SPS PDSCH transmission, wherein the DMRS is received in a first set of one or more symbols associated with the SPS PDSCH transmission, wherein the DCI message is received in a second set of one or more symbols associated with the SPS PDSCH transmission, and wherein the second set of one or more symbols immediately follows the first set of one or more symbols.
Aspect 3: The method of any of Aspects 1-2, further comprising receiving a demodulation reference signal (DMRS) in the SPS PDSCH transmission, wherein the DMRS is received in a set of one or more symbols associated with the SPS PDSCH transmission and is frequency-division multiplexed in the set of one or more symbols in accordance with a first comb pattern, and wherein the DCI message is frequency-division multiplexed in the set of one or more symbols in accordance with a second comb pattern.
Aspect 4: The method of any of Aspects 1-3, wherein the DCI message indicates one or more transmission parameters associated with one or more SPS PDSCH transmissions of the series of SPS PDSCH transmissions.
Aspect 5: The method of Aspect 4, further comprising receiving configuration information that configures a periodicity for including one or more DCI messages in a subset of SPS PDSCH transmissions of the series of SPS PDSCH transmissions, wherein monitoring the series of SPS PDSCH transmissions for DCI is in accordance with the periodicity.
Aspect 6: The method of Aspect 4, wherein the DCI message indicates a change in a time-domain location of a subsequent SPS PDSCH transmission of the series of SPS PDSCH transmissions.
Aspect 7: The method of Aspect 6, wherein the DCI message indicates the change in the time-domain location of the subsequent SPS PDSCH transmission using a KO field of a PDSCH time domain resource allocation.
Aspect 8: The method of Aspect 4, further comprising transmitting a hybrid automatic repeat request acknowledgment (HARQ ACK) message associated with the SPS PDSCH transmission, wherein the one or more SPS PDSCH transmissions are one or more SPS PDSCH transmissions that occur after transmission of the HARQ ACK message.
Aspect 9: The method of any of Aspects 1-8, wherein the DCI message schedules a dynamic grant PDSCH.
Aspect 10: The method of any of Aspects 1-9, further comprising identifying whether the DCI message indicates one or more transmission parameters associated with one or more SPS PDSCH transmissions of the series of SPS PDSCH transmissions, or schedules a dynamic grant PDSCH.
Aspect 11: The method of Aspect 10, further comprising at least one of: identifying that the DCI message indicates the one or more transmission parameters associated with the one or more SPS PDSCH transmissions by identifying that a cyclic redundancy check (CRC) associated with the DCI message is scrambled by a configured scheduling radio network temporary identifier (RNTI); or identifying that the DCI message schedules the dynamic grant PDSCH by identifying that the CRC associated with the DCI message is scrambled by one of a cell RNTI or a temporary cell RNTI.
Aspect 12: A method for wireless communication by a network node, comprising: transmitting, to a user equipment (UE), configuration information that configures a series of semi-persistent scheduling (SPS) physical downlink shared channel (PDSCH) transmissions; and transmitting, to the UE, a downlink control information (DCI) message multiplexed with an SPS PDSCH transmission of the series of SPS PDSCH transmissions in accordance with the configuration information.
Aspect 13: The method of Aspect 12, further comprising transmitting, to the UE, a demodulation reference signal (DMRS) in the SPS PDSCH transmission, wherein the DMRS is transmitted in a first set of one or more symbols associated with the SPS PDSCH transmission, wherein the DCI message is transmitted in a second set of one or more symbols associated with the SPS PDSCH transmission, and wherein the second set of one or more symbols immediately follows the first set of one or more symbols.
Aspect 14: The method of any of Aspects 12-13, further comprising transmitting, to the UE, a demodulation reference signal (DMRS) in the SPS PDSCH transmission, wherein the DMRS is transmitted in a set of one or more symbols associated with the SPS PDSCH transmission and is frequency-division multiplexed in the set of one or more symbols in accordance with a first comb pattern, and wherein the DCI message is frequency-division multiplexed in the set of one or more symbols in accordance with a second comb pattern.
Aspect 15: The method of any of Aspects 12-14, wherein the DCI message indicates one or more transmission parameters associated with one or more SPS PDSCH transmission of the series of SPS PDSCH transmissions.
Aspect 16: The method of Aspect 15, further comprising transmitting, to the UE, configuration information that configures a periodicity for including one or more DCI messages in a subset of SPS PDSCH transmissions of the series of SPS PDSCH transmissions.
Aspect 17: The method of Aspect 15, wherein the DCI message indicates a change in a time-domain location of a subsequent SPS PDSCH transmission of the series of SPS PDSCH transmissions.
Aspect 18: The method of Aspect 17, wherein the DCI message indicates the change in the time-domain location of the subsequent SPS PDSCH transmission using a KO field of a PDSCH time domain resource allocation.
Aspect 19: The method of Aspect 15, further comprising receiving, from the UE, a hybrid automatic repeat request acknowledgment (HARQ ACK) message associated with the SPS PDSCH transmission, wherein the one or more SPS PDSCH transmissions are one or more SPS PDSCH transmissions that occur after transmission of the HARQ ACK message.
Aspect 20: The method of any of Aspects 12-19, wherein the DCI message schedules a dynamic grant PDSCH.
Aspect 21: The method of any of Aspects 12-20, further comprising at least one of: scrambling a cyclic redundancy check (CRC) associated with the DCI message by a configured scheduling radio network temporary identifier (CS-RNTI), wherein scrambling the CRC by the CS-RNTI indicates that the DCI message indicates one or more transmission parameters associated with one or more SPS PDSCH transmissions of the series of SPS PDSCH transmissions; or scrambling the CRC by one of a cell RNTI (C-RNTI) or a temporary cell RNTI (TC-RNTI), wherein scrambling the CRC by the one of the C-RNTI or the TC-RNTI indicates that the DCI schedules a dynamic grant PDSCH.
Aspect 22: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-21.
Aspect 23: An apparatus for wireless communication at a device, the apparatus comprising one or more memories and one or more processors coupled to the one or more memories, the one or more processors configured to cause the device to perform the method of one or more of Aspects 1-21.
Aspect 24: An apparatus for wireless communication, the apparatus comprising at least one means for performing the method of one or more of Aspects 1-21.
Aspect 25: A non-transitory computer-readable medium storing code for wireless communication, the code comprising instructions executable by one or more processors to perform the method of one or more of Aspects 1-21.
Aspect 26: A non-transitory computer-readable medium storing a set of instructions for wireless communication, the set of instructions comprising one or more instructions that, when executed by one or more processors of a device, cause the device to perform the method of one or more of Aspects 1-21.
Aspect 27: A device for wireless communication, the device comprising a processing system that includes one or more processors and one or more memories coupled with the one or more processors, the processing system configured to cause the device to perform the method of one or more of Aspects 1-21.
Aspect 28: An apparatus for wireless communication at a device, the apparatus comprising one or more memories and one or more processors coupled to the one or more memories, the one or more processors individually or collectively configured to cause the device to perform the method of one or more of Aspects 1-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
receive configuration information that configures a series of semi-persistent scheduling (SPS) physical downlink shared channel (PDSCH) transmissions;
monitor the series of SPS PDSCH transmissions for downlink control information (DCI) in accordance with the configuration information; and
receive a DCI message multiplexed with an SPS PDSCH transmission of the series of SPS PDSCH transmissions.

2. The UE of claim 1, wherein the processing system is further configured to cause the UE to receive a demodulation reference signal (DMRS) in the SPS PDSCH transmission,
wherein the DMRS is received in a first set of one or more symbols associated with the SPS PDSCH transmission,
wherein the DCI message is received in a second set of one or more symbols associated with the SPS PDSCH transmission, and
wherein the second set of one or more symbols immediately follows the first set of one or more symbols.

3. The UE of claim 1, wherein the processing system is further configured to cause the UE to receive a demodulation reference signal (DMRS) in the SPS PDSCH transmission,
wherein the DMRS is received in a set of one or more symbols associated with the SPS PDSCH transmission and is frequency-division multiplexed in the set of one or more symbols in accordance with a first comb pattern, and
wherein the DCI message is frequency-division multiplexed in the set of one or more symbols in accordance with a second comb pattern.

4. The UE of claim 1, wherein the DCI message indicates one or more transmission parameters associated with one or more SPS PDSCH transmissions of the series of SPS PDSCH transmissions.

5. The UE of claim 4, wherein the processing system is further configured to cause the UE to receive configuration information that configures a periodicity for including one or more DCI messages in a subset of SPS PDSCH transmissions of the series of SPS PDSCH transmissions, and
wherein, to cause the UE to monitor the series of SPS PDSCH transmissions for DCI, the processing system is configured to cause the UE to monitor the series of SPS PDSCH transmission for DCI in accordance with the periodicity.

6. The UE of claim 4, wherein the DCI message indicates a change in a time-domain location of a subsequent SPS PDSCH transmission of the series of SPS PDSCH transmissions.

7. The UE of claim 6, wherein the DCI message indicates the change in the time-domain location of the subsequent SPS PDSCH transmission using a K0 field of a PDSCH time domain resource allocation.

8. The UE of claim 4, wherein the processing system is further configured to cause the UE to transmit a hybrid automatic repeat request acknowledgment (HARQ ACK) message associated with the SPS PDSCH transmission,
wherein the one or more SPS PDSCH transmissions are one or more SPS PDSCH transmissions that occur after transmission of the HARQ ACK message.

9. The UE of claim 1, wherein the DCI message schedules a dynamic grant PDSCH.

10. The UE of claim 1, wherein the processing system is further configured to cause the UE to identify whether the DCI message indicates one or more transmission parameters associated with one or more SPS PDSCH transmissions of the series of SPS PDSCH transmissions, or schedules a dynamic grant PDSCH.

11. The UE of claim 10, wherein the processing system is further configured to cause the UE to at least one of:
identify that the DCI message indicates the one or more transmission parameters associated with the one or more SPS PDSCH transmissions by identifying that a cyclic redundancy check (CRC) associated with the DCI message is scrambled by a configured scheduling radio network temporary identifier (RNTI); or
identify that the DCI message schedules the dynamic grant PDSCH by identifying that the CRC associated with the DCI message is scrambled by one of a cell RNTI or a temporary cell RNTI.

12. A network node for wireless communication, comprising:
a processing system that includes one or more processors and one or more memories coupled with the one or more processors, the processing system configured to cause the network node to:
transmit, to a user equipment (UE), configuration information that configures a series of semi-persistent scheduling (SPS) physical downlink shared channel (PDSCH) transmissions; and
transmit, to the UE, a downlink control information (DCI) message multiplexed with an SPS PDSCH transmission of the series of SPS PDSCH transmissions in accordance with the configuration information.

13. The network node of claim 12, wherein the processing system is further configured to cause the network node to transmit, to the UE, a demodulation reference signal (DMRS) in the SPS PDSCH transmission,
wherein the DMRS is transmitted in a first set of one or more symbols associated with the SPS PDSCH transmission,
wherein the DCI message is transmitted in a second set of one or more symbols associated with the SPS PDSCH transmission, and
wherein the second set of one or more symbols immediately follows the first set of one or more symbols.

14. The network node of claim 12, wherein the processing system is further configured to cause the network node to transmit, to the UE, a demodulation reference signal (DMRS) in the SPS PDSCH transmission,
wherein the DMRS is transmitted in a set of one or more symbols associated with the SPS PDSCH transmission and is frequency-division multiplexed in the set of one or more symbols in accordance with a first comb pattern, and
wherein the DCI message is frequency-division multiplexed in the set of one or more symbols in accordance with a second comb pattern.

15. The network node of claim 12, wherein the DCI message indicates one or more transmission parameters associated with one or more SPS PDSCH transmission of the series of SPS PDSCH transmissions.

16. The network node of claim 15, wherein the processing system is further configured to cause the network node to transmit, to the UE, configuration information that configures a periodicity for including one or more DCI messages in a subset of SPS PDSCH transmissions of the series of SPS PDSCH transmissions.

17. The network node of claim 15, wherein the DCI message indicates a change in a time-domain location of a subsequent SPS PDSCH transmission of the series of SPS PDSCH transmissions.

18. The network node of claim 17, wherein the DCI message indicates the change in the time-domain location of the subsequent SPS PDSCH transmission using a K0 field of a PDSCH time domain resource allocation.

19. The network node of claim 15, wherein the processing system is further configured to cause the network node to receive, from the UE, a hybrid automatic repeat request acknowledgment (HARQ ACK) message associated with the SPS PDSCH transmission,
wherein the one or more SPS PDSCH transmissions are one or more SPS PDSCH transmissions that occur after transmission of the HARQ ACK message.

20. The network node of claim 12, wherein the DCI message schedules a dynamic grant PDSCH.

21. The network node of claim 12, wherein the processing system is further configured to cause the network node to at least one of:
scramble a cyclic redundancy check (CRC) associated with the DCI message by a configured scheduling radio network temporary identifier (CS-RNTI),
wherein scrambling the CRC by the CS-RNTI indicates that the DCI message indicates one or more transmission parameters associated with one or more SPS PDSCH transmissions of the series of SPS PDSCH transmissions; or scramble the CRC by one of a cell RNTI (C-RNTI) or a temporary cell RNTI (TC-RNTI),
wherein scrambling the CRC by the one of the C-RNTI or the TC-RNTI indicates that the DCI schedules a dynamic grant PDSCH.

22. A method for wireless communication by a user equipment (UE), comprising:
receiving configuration information that configures a series of semi-persistent scheduling (SPS) physical downlink shared channel (PDSCH) transmissions;
monitoring the series of SPS PDSCH transmissions for downlink control information (DCI) in accordance with the configuration information; and
receiving a DCI message multiplexed with an SPS PDSCH transmission of the series of SPS PDSCH transmissions.

23. The method of claim 22, further comprising receiving a demodulation reference signal (DMRS) in the SPS PDSCH transmission,
wherein the DMRS is received in a first set of one or more symbols associated with the SPS PDSCH transmission,
wherein the DCI message is received in a second set of one or more symbols associated with the SPS PDSCH transmission, and
wherein the second set of one or more symbols immediately follows the first set of one or more symbols.

24. The method of claim 22, further comprising receiving a demodulation reference signal (DMRS) in the SPS PDSCH transmission,
wherein the DMRS is received in a set of one or more symbols associated with the SPS PDSCH transmission and is frequency-division multiplexed in the set of one or more symbols in accordance with a first comb pattern, and
wherein the DCI message is frequency-division multiplexed in the set of one or more symbols in accordance with a second comb pattern.

25. The method of claim 22, wherein the DCI message indicates one or more transmission parameters associated with one or more SPS PDSCH transmissions of the series of SPS PDSCH transmissions.

26. The method of claim 25, further comprising receiving configuration information that configures a periodicity for including one or more DCI messages in a subset of SPS PDSCH transmissions of the series of SPS PDSCH transmissions,
wherein monitoring the series of SPS PDSCH transmissions for DCI is in accordance with the periodicity.

27. The method of claim 22, wherein the DCI message schedules a dynamic grant PDSCH.

28. A method for wireless communication by a network node, comprising:
transmitting, to a user equipment (UE), configuration information that configures a series of semi-persistent scheduling (SPS) physical downlink shared channel (PDSCH) transmissions; and
transmitting, to the UE, a downlink control information (DCI) message multiplexed with an SPS PDSCH transmission of the series of SPS PDSCH transmissions in accordance with the configuration information.

29. The method of claim 28, wherein the DCI message indicates one or more transmission parameters associated with one or more SPS PDSCH transmission of the series of SPS PDSCH transmissions.

30. The method of claim 28, wherein the DCI message schedules a dynamic grant PDSCH.
